(19) United States
(12) Patent Application Publication
(10) Pub. No.: US 2024/0176522 A1
(43) Pub. Date: May 30, 2024

(54) COMPUTER-READABLE RECORDING MEDIUM STORING INFORMATION PROCESSING PROGRAM, INFORMATION PROCESSING METHOD, AND INFORMATION PROCESSING APPARATUS

(71) Applicant: Fujitsu Limited, Kawasaki-shi (JP)

(72) Inventor: Takashi KATOH, Kawasaki (JP)

(73) Assignee: Fujitsu Limited, Kawasaki-shi (JP)

(21) Appl. No.: 18/507,155

(22) Filed: Nov. 13, 2023

(30) Foreign Application Priority Data
Nov. 29, 2022 (JP) 2022-189893

(51) Int. Cl. G06F 3/06

(52) U.S. Cl. CPC G06F 3/064; G06F 3/0688; G06F 3/0604

(57) ABSTRACT

An information processing program causes a computer to store a plurality of block strings that represents arrays in which blocks associated with a predetermined number of components of an array are coupled. For each block string, the computer manages the block string such that, when there is a front block corresponding only to components for which a value has not been set in a first half portion of the block string, at least a plurality of areas that is a part of a last block is unused areas where values of components are not stored, by distributing values of a rear block in a latter half portion to the front block. A pointer indicating a position at which the block string is divided and initial values of components are also managed by using a second area of the plurality of areas in the last block of the each block string.

### CROSS-REFERENCE TO RELATED APPLICATION

This application is based upon and claims the benefit of priority of the prior Japanese Patent Application No. 2022-189893, filed on Nov. 29, 2022, the entire contents of which are incorporated herein by reference.

### FIELD

The embodiment discussed herein is related to a computer-readable recording medium storing an information processing program, an information processing method, and an information processing apparatus.

### BACKGROUND

Heretofore, there has been a technique of representing an array by using a block string of a data structure called a block wise optional array in which blocks capable of storing the values of a predetermined number of components of the array are coupled. For example, there is a case where management is performed such that, when there is a front block in which the value of a component of an array is not stored in the first half portion obtained by dividing a block string into two front and rear portions, the values of some components requested to be stored in a rear block in a latter half portion are distributed to the front block. For example, for each block string, a stack pointer indicating the variable position at which the block string is divided and flag information indicating whether all components of an array have been stored in the block string are stored.

As related art, for example, there is a technique of controlling an array configured by connecting a plurality of blocks, the array having a boundary at a position where the number of unwritten blocks in a first area obtained by dividing the plurality of blocks into two and the number of written blocks in a second area obtained by dividing the plurality of blocks into two are in an integer ratio.

Japanese Laid-open Patent Publication No. 2018-037010 is disclosed as related art.

### SUMMARY

According to an aspect of the embodiments, a computer-readable recording medium storing an information processing program for causing a computer to execute a process including: storing a plurality of block strings that represents different arrays in which blocks associated with a predetermined number of components of an array are coupled; in each block string of the plurality of block strings, managing the block string such that, when there is a front block corresponding only to components for which a value has not been set in a first half portion of two portions obtained by dividing the block string, at least a plurality of areas that is a part of a last block is unused areas where values of components are not stored, by distributing values of some components corresponding to a rear block in a latter half portion to the front block; in a first area string in which first areas of the plurality of areas in a last block of the each block string are coupled, when there is a front area corresponding only to components for which a value has not been set in a first half portion of two portions obtained by dividing the first area string, managing the first area string such that values of some components corresponding to a rear area in a latter half portion are distributed to the front area; for the each block string, holding a pair of a pointer that indicates a variable position at which the block string is divided and an initial value of components for which a value has not been set in the block string, by using a second area of the plurality of areas in the last block of the each block string; and storing flag information that indicates whether there is an option area corresponding only to components for which a value has not been set in the first area string, wherein according to the flag information, the each block string is treated as a block string in which there is an option block corresponding only to components for which a value has not been set when the first area that is a part of a last block is the option area, and is treated as a block string in which there is no option block when the first area that is a part of a last block is not the option area.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an explanatory diagram illustrating an exemplary embodiment of an information processing method according to an embodiment;

FIG. 2 is an explanatory diagram illustrating an example of an information processing system;

FIG. 3 is a block diagram illustrating an example of a hardware configuration of an information processing apparatus;

FIG. 4 is a block diagram illustrating an example of a functional configuration of the information processing apparatus;

FIG. 5 is an explanatory diagram illustrating an example of a data structure of a block string;

FIG. 6 is an explanatory diagram illustrating a first example in which a plurality of block strings is stored;

FIG. 7 is an explanatory diagram illustrating a second example in which the plurality of block strings is stored;

FIG. 8 is an explanatory diagram illustrating an example of application of the information processing apparatus (part 1);

FIG. 9 is an explanatory diagram illustrating an example of application of the information processing apparatus (part 2);

FIG. 10 is an explanatory diagram illustrating an example of application of the information processing apparatus (part 3);

FIG. 11 is an explanatory diagram illustrating an example of application of the information processing apparatus (part 4);

FIG. 12 is an explanatory diagram illustrating an example of application of the information processing apparatus (part 5);

FIG. 13 is an explanatory diagram illustrating an example of application of the information processing apparatus (part 6);

FIG. 14 is an explanatory diagram illustrating an example of application of the information processing apparatus (part 7);

FIG. 15 is an explanatory diagram illustrating an example of application of the information processing apparatus (part 8);

FIG. 16 is an explanatory diagram illustrating an example of application of the information processing apparatus (part 9);

FIG. 17 is an explanatory diagram illustrating an example of application of the information processing apparatus (part 10);

FIG. 18 is a flowchart illustrating an example of a procedure of entire initialization processing;

FIG. 19 is a flowchart illustrating an example of a procedure of row initialization processing;

FIG. 20 is a flowchart illustrating an example of a procedure of write processing; and

FIG. 21 is a flowchart illustrating an example of a procedure of read processing.

### DESCRIPTION OF EMBODIMENTS

In the related art, there is a problem that an increase in the amount of data is caused when a plurality of arrays is represented. For example, an increase in the amount of data is caused when flag information indicating whether all components of an array have been stored in a block string representing the array is prepared for each array.

According to one aspect, an object of the present disclosure is to suppress an increase in the amount of data.

Hereinafter, an embodiment of an information processing program, an information processing method, and an information processing apparatus according to the present disclosure will be described in detail with reference to the drawings.

### Exemplary Embodiment of Information Processing Method According to Embodiment

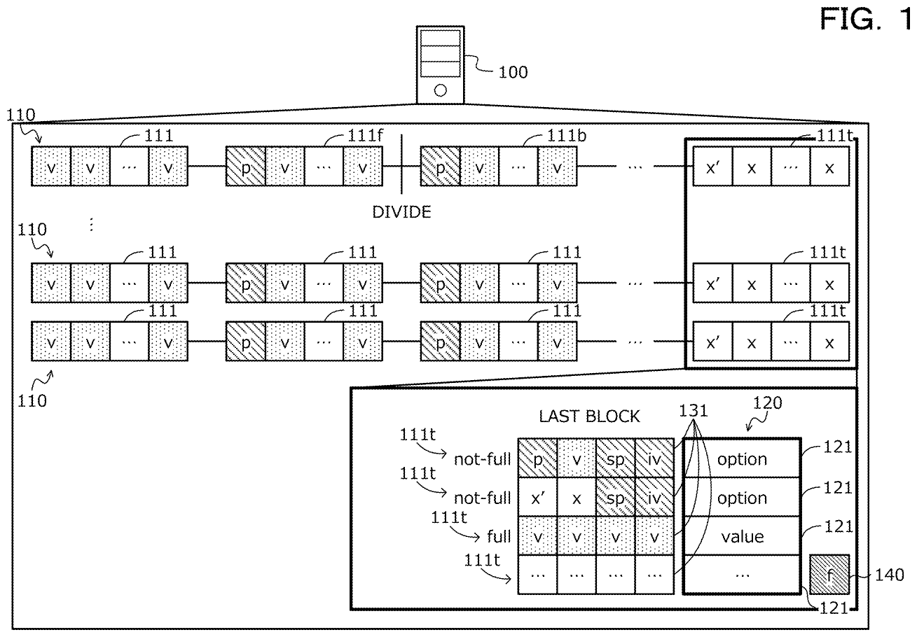

FIG. 1 is an explanatory diagram illustrating an exemplary embodiment of the information processing method according to the embodiment. An information processing apparatus 100 is a computer for storing a plurality of arrays. For example, the information processing apparatus 100 is a server, a personal computer (PC), or the like.

For example, an array is considered to be data used for real-time transactions, online games, automatic driving, security measures, or the like. From the viewpoint of using an array, it is desired to achieve reduction of the processing load and processing time taken when an array is managed. For example, it is desired to make it easier to initialize components of an array.

For this reason, it is conceivable that an array is represented by a block string having a special data structure. For example, it is conceivable that a data structure called block wise optional array is employed as the data structure of a block string.

For example, a block string having the data structure called block wise optional array is divided into two front and rear portions. The position at which the block string is divided is variable. For example, the position at which the block string is divided may be changed in response to the storage of the value of a component of the array in the block string.

In the following description, when none of the values of a predetermined number of components associated with a block have been set, there are cases where the state of the block is referred to as an “option state”. For example, if none of the values of components associated with a block are requested to be stored yet, the block is in the option state. In the following description, when the value of at least any of a predetermined number of components associated with a block has been set, there are cases where the state of the block is referred to as a “value state”.

In the following description, when all components of an array have been stored in a block string and there is no block in the option state, there are cases where the state of the block string is referred to as a “full state”. In the following description, when there is a component of an array for which a value has not been set and there is a block in the option state in a block string, there are cases where the state of the block string is referred to as a “not-full state”.

For example, when there is a front block in the option state in the first half portion obtained by dividing a block string, the block string may be managed such that the values of some components associated with a rear block in the value state in the latter half portion are distributed to the front block. Accordingly, when a block string is in the not-full state, the block string may be managed such that at least a part of the last block of the block string is an unused area where the value of a component is not stored. When a block string is in the full state, since all components of an array have been stored in the block string, the last block of the block string does not include an unused area where the value of a component is not stored.

For example, in order to make it easier to initialize components of an array, an initial value is stored in association with a block string, and the values of a predetermined number of components associated with a block in the option state in the block string are regarded as the stored initial value. There is a data structure called optimal space initializable array (OSIA) in which the data structure called block wise optional array is extended so that an initial value is stored in a block string.

In the data structure called optimal space initializable array, for example, an initial value is held by using an unused area in the last block of a block string. For example, Japanese Laid-open Patent Publication No. 2018-037010 described above may be referred to for the data structure called optimal space initializable array.

For example, for each block string, it is desired to manage the variable position at which the block string is divided, and to manage whether the block string is in the full state or in the not-full state. For example, in order to enable determination of whether each block of a block string is in the option state or in the value state, it is desired to manage the variable position at which the block string is divided, and to manage whether the block string is in the full state.

In related art, for example, in order to manage the variable position at which a block string is divided, a stack pointer indicating the variable position at which the block string is divided is stored in association with the block string. For example, the stack pointer may be held by using an unused area in the last block of a block string. In related art, for example, in order to manage whether a block string is in the full state or in the not-full state, flag information indicating whether the block string is in the full state is stored in association with the block string.

However, in related art, there is a problem that an increase in the amount of data is caused when a plurality of block strings representing different arrays is stored in order to represent a plurality of arrays. For example, since flag information is stored for each array in association with a block string representing the array, an increase in the number of arrays to be represented leads to an increase in the amount of data.

Accordingly, in the present embodiment, description will be given for an information processing method that may suppress an increase in the amount of data used when a plurality of block strings representing different arrays is stored.

In FIG. 1, the information processing apparatus 100 stores a plurality of block strings 110 representing different arrays in which blocks 111 associated with a predetermined number of components of an array are coupled. For example, the information processing apparatus 100 stores block strings representing different arrays and having the data structure called optimal space initializable array.

(1-1) The information processing apparatus 100 manages each block string 110 by dividing the block string into two portions. The information processing apparatus 100 manages each block string 110 such that, when there is a front block 111f in the option state in the first half portion, the values of some components corresponding to a rear block 111b in the value state in the latter half portion are distributed to the front block 111f. FIG. 1 shows a state after such the distribution is performed. Accordingly, the information processing apparatus 100 may manage each block string 110 such that at least a plurality of areas being a part of the last block 111t of the block string 110 is unused areas where the values of components are not stored.

(1-2) The information processing apparatus 100 connects first areas 121 of the plurality of areas in the last block 111t of each block string 110, and manages the coupled areas as a first area string 120. For example, the information processing apparatus 100 manages the first area string 120 as the data structure called optimal space initializable array. In the following description, as in the case of the blocks 111, when none of the values of the components associated with the first area 121 have been set, there are cases where the state of the first area 121 is referred to as the “option state”. In the following description, as in the case of the blocks 111, when the value of at least any of the components associated with the first area 121 has been set, there are cases where the state of the first area 121 is referred to as the “value state”.

(1-3) The information processing apparatus 100 manages the first area string 120 by dividing the first area string into two portions. The information processing apparatus 100 manages the first area string 120 such that, when there is a front area 121 in the option state in the first half portion, the values of some components corresponding to a rear area 121 in the latter half portion are distributed to the front area 121.

(1-4) The information processing apparatus 100 holds a pointer sp indicating the variable position at which each block string 110 is divided and an initial value iv of components for which a value has not been set in each block string 110. For example, the information processing apparatus 100 holds a pair of the pointer sp and the initial value iv for each block string 110 by using a second area 131 of the plurality of areas in the last block 111t of each block string 110. Here, p is a pointer indicating a relationship between two blocks.

For example, for each block string 110, the information processing apparatus 100 holds a pair of the pointer sp and the initial value iv for the block string 110 by storing the pair in the second area 131 in the last block 111t of the block string. Accordingly, the information processing apparatus 100 may appropriately manage the variable position at which each block string 110 is divided, and may appropriately manage the initial value iv of components for which a value has not been set in each block string 110.

(1-5) The information processing apparatus 100 stores flag information 140 indicating whether there is the first area 121 in the option state in the first area string 120. For example, the value 0 of the flag information 140 indicates that there is the first area 121 in the option state. For example, the value 1 of the flag information 140 indicates that there is no first area 121 in the option state. Accordingly, the information processing apparatus 100 may appropriately manage whether each first area 121 in the first area string 120 is in the option state or in the value state.

(1-6) The information processing apparatus 100 determines whether the first area 121 being a part of the last block 111t is in the option state for each block string 110 by using the flag information 140. When it is determined that the first area 121 being a part of the last block 111t is in the option state for any block string 110, the information processing apparatus 100 treats the block string 110 as being in the not-full state. On the other hand, when it is determined that the first area 121 being a part of the last block 111t is not in the option state for any block string 110, the information processing apparatus 100 treats the block string 110 as being in the full state.

Accordingly, the information processing apparatus 100 does not have to prepare flag information indicating whether the block string 110 is in the full state or in the not-full state for each block string 110. For this reason, the information processing apparatus 100 may suppress an increase in the amount of data used when a plurality of block strings representing different arrays is stored.

Although a case has been described in which the information processing apparatus 100 manages each second area 131 in the last block 111t of a block string as an independent area, the embodiment is not limited to this case. For example, there may be a case where the information processing apparatus 100 connects the second areas 131 of the plurality of areas in the last block 111t of each block string 110, and manages the coupled areas as a second area string. For example, the information processing apparatus 100 manages the second area string as the data structure called optimal space initializable array.

Although a case has been described in which the information processing apparatus 100 operates alone, the embodiment is not limited to this case. For example, there may be a case where the information processing apparatus 100 is in cooperation with another computer. For example, there may be a case where the information processing apparatus 100 controls another computer that stores the plurality of block strings 110. For example, there may be a case where a plurality of computers implements the function of the information processing apparatus 100 in cooperation with each other. For example, there may be a case where the function of the information processing apparatus 100 is implemented on a cloud.

### Example of Information Processing System 200

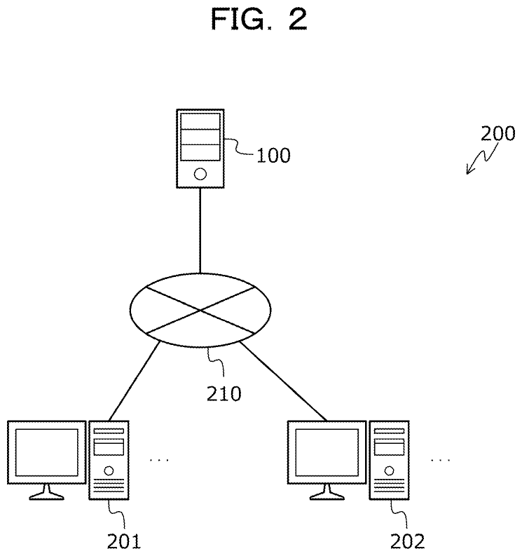

Next, an example of an information processing system 200 in which the information processing apparatus 100 illustrated in FIG. 1 is applied will be described with reference to FIG. 2.

FIG. 2 is an explanatory diagram illustrating an example of the information processing system 200. In FIG. 2, the information processing system 200 includes the information processing apparatus 100, an information accumulation apparatus 201, and a client apparatus 202.

In the information processing system 200, the information processing apparatus 100 and the information accumulation apparatus 201 are coupled to each other via a wired or wireless network 210. For example, the network 210 is a local area network (LAN), a wide area network (WAN), the Internet, or the like. In the information processing system 200, the information processing apparatus 100 and the client apparatus 202 are coupled to each other via the wired or wireless network 210.

The information accumulation apparatus 201 is a computer for storing a plurality of block strings representing different arrays. For example, the information accumulation apparatus 201 stores a plurality of block strings each having the data structure called optimal space initializable array. For example, the information accumulation apparatus 201 is used by a system administrator who manages the information processing system 200.

The information accumulation apparatus 201 treats a first area string in which first areas of a plurality of areas in the last block of each block string of the plurality of block strings are coupled, as the data structure called optimal space initializable array. The information accumulation apparatus 201 treats a second area string in which second areas of a plurality of areas in the last block of each block string of the plurality of block strings are coupled, as the data structure called optimal space initializable array.

The information accumulation apparatus 201 stores a stack pointer indicating the position at which each block string is divided. For example, the information accumulation apparatus 201 manages each block string such that the stack pointer indicating the position at which each block string is divided is stored by using the second area string. The information accumulation apparatus 201 stores flag information indicating whether there is a first area in the option state in the first area string.

The information accumulation apparatus 201 controls a block string in accordance with the control of the information processing apparatus 100. The information accumulation apparatus 201 stores the values of components of an array in a block string in accordance with the control of the information processing apparatus 100. The information accumulation apparatus 201 updates the stack pointer indicating the position at which a block string is divided, a stack pointer indicating the position at which the first area string is divided, a stack pointer indicating the position at which the second area string is divided, and the like, in accordance with the control of the information processing apparatus 100. The information accumulation apparatus 201 updates the flag information in accordance with the control of the information processing apparatus 100. For example, the information accumulation apparatus 201 is a server, a PC, or the like.

The information processing apparatus 100 is a computer for controlling the information accumulation apparatus 201. For example, the information processing apparatus 100 is used by the system administrator who manages the information processing system 200.

The information processing apparatus 100 acquires a storage request that requests storage of the value of a component of an array. For example, the information processing apparatus 100 acquires a storage request by receiving the storage request from the client apparatus 202. For example, the information processing apparatus 100 may acquire a storage request by receiving input of the storage request based on the input operation of the system administrator. The information processing apparatus 100 controls a plurality of block strings by controlling the information accumulation apparatus 201 in response to the storage request.

The information processing apparatus 100 acquires an individual initialization request that requests initialization of a block string. For example, the information processing apparatus 100 acquires an individual initialization request by receiving the individual initialization request from the client apparatus 202. For example, the information processing apparatus 100 may acquire an individual initialization request by receiving input of the individual initialization request based on the input operation of the system administrator. The information processing apparatus 100 controls a plurality of block strings by controlling the information accumulation apparatus 201 in response to the individual initialization request.

The information processing apparatus 100 acquires an entire initialization request that requests initialization of the entire plurality of block strings. For example, the information processing apparatus 100 acquires an entire initialization request by receiving the entire initialization request from the client apparatus 202. For example, the information processing apparatus 100 may acquire an entire initialization request by receiving input of the entire initialization request based on the input operation of the system administrator. The information processing apparatus 100 controls a plurality of block strings by controlling the information accumulation apparatus 201 in response to the entire initialization request. For example, the information processing apparatus 100 is a server, a PC, or the like.

The client apparatus 202 is a computer used by a system user who uses the information processing system 200. The client apparatus 202 generates a storage request, an individual initialization request, an entire initialization request, or the like based on the input operation of the system user, and transmits the request to the information processing apparatus 100. For example, the client apparatus 202 is a PC, a tablet terminal, a smartphone, or the like.

Although a case has been described in which the information processing apparatus 100 is an apparatus different from the information accumulation apparatus 201, the embodiment is not limited to this case. For example, there may be a case where the information processing apparatus 100 has the function as the information accumulation apparatus 201 and also operates as the information accumulation apparatus 201. Although a case has been described in which the information processing apparatus 100 is an apparatus different from the client apparatus 202, the embodiment is not limited to this case. For example, there may be a case where the information processing apparatus 100 has the function as the client apparatus 202 and also operates as the client apparatus 202.

### Example of Application of Information Processing Apparatus 100

Next, an example of application of the information processing apparatus 100 will be described. For example, the information processing apparatus 100 may be applied to price management of commodities provided by each organization of a plurality of organizations. For example, an organization is a company. For example, the information processing apparatus 100 stores and manages, for each organization, a plurality of block strings obtained by putting together the block strings each representing an array in which the price of each commodity of two or more commodities provided by the organization is held as the value of a component. Accordingly, the information processing apparatus 100 may achieve reduction of the amount of data used when the prices of the commodities provided by each organization are managed. The information processing apparatus 100 may appropriately manage the prices of the commodities provided by each organization.

### Example of Hardware Configuration of Information Processing Apparatus 100

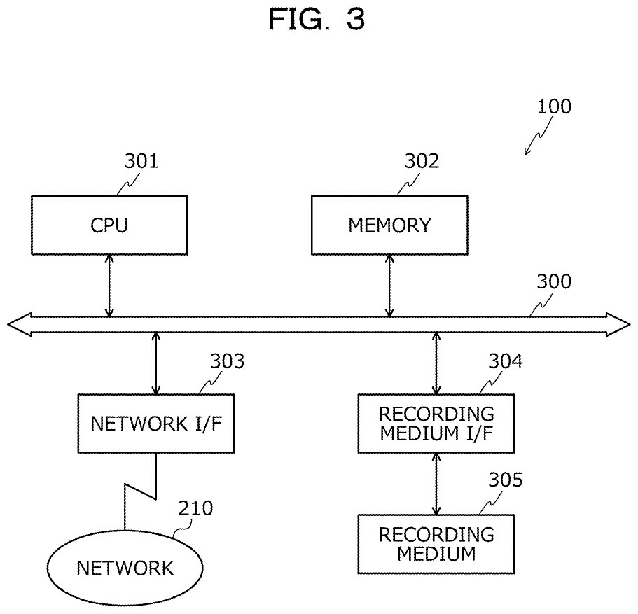

Next, an example of a hardware configuration of the information processing apparatus 100 will be described with reference to FIG. 3.

FIG. 3 is a block diagram illustrating an example of a hardware configuration of the information processing apparatus 100. In FIG. 3, the information processing apparatus 100 includes a central processing unit (CPU) 301, a memory 302, a network interface (I/F) 303, a recording medium I/F 304, and a recording medium 305. These components are coupled to one another through a bus 300.

The CPU 301 controls the entire information processing apparatus 100. For example, the memory 302 includes a read-only memory (ROM), a random-access memory (RAM), a flash ROM, and the like. For example, the flash ROM or the ROM stores various programs, and the RAM is used as a work area for the CPU 301. The programs stored in the memory 302 are loaded into the CPU 301, thereby causing the CPU 301 to execute the coded processing.

The network I/F 303 is coupled to the network 210 through a communication line, and is coupled to another computer via the network 210. The network I/F 303 serves as an interface between the network 210 and the internal components, and controls input and output of data from and to the other computer. For example, the network I/F 303 is a modem, a LAN adapter, or the like.

The recording medium I/F 304 controls reading and writing of data from and to the recording medium 305 in accordance with the control of the CPU 301. For example, the recording medium I/F 304 is a disk drive, a solid-state drive (SSD), a Universal Serial Bus (USB) port, or the like. The recording medium 305 is a nonvolatile memory that stores data written under the control of the recording medium I/F 304. For example, the recording medium 305 is a disk, a semiconductor memory, a USB memory, or the like. The recording medium 305 may be removably attached to the information processing apparatus 100.

In addition to the components described above, for example, the information processing apparatus 100 may include a keyboard, a mouse, a display, a printer, a scanner, a microphone, a speaker, and the like. The information processing apparatus 100 may include a plurality of recording medium I/Fs 304 and a plurality of recording media 305. The information processing apparatus 100 does not have to include the recording medium I/F 304 and the recording medium 305.

### Example of Hardware Configuration of Information Accumulation Apparatus 201

For example, an example of a hardware configuration of the information accumulation apparatus 201 is similar to the example of a hardware configuration of the information processing apparatus 100 illustrated in FIG. 3, and thus description thereof will be omitted.

### Example of Hardware Configuration of Client Apparatus 202

For example, an example of a hardware configuration of the client apparatus 202 is similar to the example of a hardware configuration of the information processing apparatus 100 illustrated in FIG. 3, and thus description thereof will be omitted.

### Example of Functional Configuration of Information Processing Apparatus 100

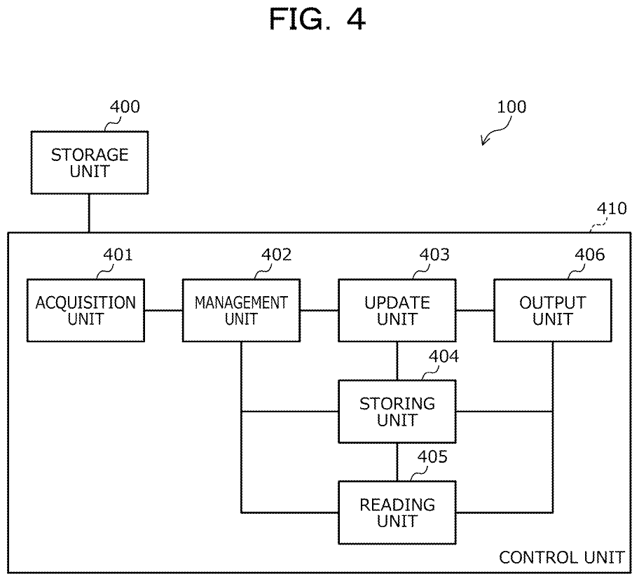

Next, an example of a functional configuration of the information processing apparatus 100 will be described with reference to FIG. 4.

FIG. 4 is a block diagram illustrating an example of a functional configuration of the information processing apparatus 100. The information processing apparatus 100 includes a storage unit 400, an acquisition unit 401, a management unit 402, an update unit 403, a storing unit 404, a reading unit 405, and an output unit 406.

For example, the storage unit 400 is realized by a storage area such as the memory 302 or the recording medium 305 illustrated in FIG. 3. Although a case will be described below in which the storage unit 400 is included in the information processing apparatus 100, the embodiment is not limited to this case. For example, there may be a case where the storage unit 400 is included in an apparatus different from the information processing apparatus 100 and the information processing apparatus 100 is allowed to refer to the storage contents of the storage unit 400.

The acquisition unit 401, the management unit 402, the update unit 403, the storing unit 404, the reading unit 405, and the output unit 406 function as an example of a control unit 410. For example, the functions of each of the units in the control unit 410 are implemented by causing the CPU 301 to execute a program stored in the storage area such as the memory 302 or the recording medium 305 illustrated in FIG. 3, or by using the network I/F 303. For example, a processing result of each functional unit is stored in the storage area such as the memory 302 or the recording medium 305 illustrated in FIG. 3.

The storage unit 400 stores various types of information to be referred to or updated in the processing of each functional unit. For example, the storage unit 400 stores a plurality of block strings representing different arrays in which blocks associated with a predetermined number of components of an array are coupled. Each block string is treated as the data structure of block-wise optional array. For example, each block string is divided into two front and rear portions.

When the values of a predetermined number of components associated with a block of a block string have not been set, there are cases where the state of the block is referred to as the “option state”. When the value of at least any component of a predetermined number of components associated with a block of a block string is set, there are cases where the state of the block is referred to as the “value state”. The last block of each block string may be divided into a plurality of areas. For example, the plurality of areas includes a first area and a second area. For example, the second area is associated with a pair of a pointer indicating the variable position at which a block string including the second area is divided and an initial value of components for which a value has not been set in the block string.

For example, the first areas of the plurality of areas in the last block of each block string form a first area string. For example, the first area string is an area string in which the first areas of the plurality of areas in the last block of each block string are sequentially coupled across the plurality of block strings. For example, the first area string is treated as the data structure of block-wise optional array. When none of the values of the components associated with the first area have been set, there are cases where the state of the first area is referred to as the “option state”. When the value of at least any component associated with the first area has been set, there are cases where the state of the first area is referred to as the “value state”.

For example, the second areas of the plurality of areas in the last block of each block string may form a second area string. For example, the second area string is an area string in which the second areas of the plurality of areas in the last block of each block string are sequentially coupled across the plurality of block strings. For example, the second area string is treated as the data structure of block-wise optional array. When the pair of a pointer indicating the variable position at which a block string including the second area is divided and an initial value of components for which a value has not been set in the block string, the pair being associated with the second area, has not been set, there are cases where the state of the second area is referred to as the “option state”. When the pair of a pointer indicating the variable position at which a block string including the second area is divided and an initial value of components for which a value has not been set in the block string, the pair being associated with the second area, has been set, there are cases where the state of the second area is referred to as the “value state”. For example, the second areas of the plurality of areas in the last block of each block string may be independent of each other without forming the second area string.

The storage unit 400 stores the flag information indicating whether there is a first area in the option state in the first area string. For example, the value 1 of the flag information indicates that there is no first area in the option state. For example, the value 0 of the flag information indicates that there is a first area in the option state.

The acquisition unit 401 acquires various types of information to be used in the processing of each functional unit. The acquisition unit 401 stores the acquired various types of information in the storage unit 400 or outputs the information to each functional unit. The acquisition unit 401 may output the various types of information stored in the storage unit 400 to each functional unit. For example, the acquisition unit 401 acquires various types of information based on the input operation of a user. For example, the acquisition unit 401 may receive various types of information from an apparatus different from the information processing apparatus 100.

The acquisition unit 401 receives an initialization request for the entire plurality of block strings. The initialization request includes designation of the entire plurality of block strings. For example, the acquisition unit 401 receives input of an initialization request for the entire plurality of block strings based on the input operation of a user. For example, the acquisition unit 401 may receive an initialization request for the entire plurality of block strings by receiving the request from another computer.

The acquisition unit 401 receives an initialization request for any entire block string of the plurality of block strings. For example, the initialization request includes information for identifying any block string of the plurality of block strings. For example, the initialization request includes an index of any block string of the plurality of block strings. For example, the acquisition unit 401 receives input of an initialization request for any entire block string of the plurality of block strings based on the input operation of a user. For example, the acquisition unit 401 may receive an initialization request for any entire block string of the plurality of block strings by receiving the request from another computer.

The acquisition unit 401 receives a write request of the value of any component of an array. For example, the write request includes information for identifying any component of the array. For example, the write request includes an index of any component of the array. For example, the acquisition unit 401 receives input of a write request of the value of any component of an array based on the input operation of a user. For example, the acquisition unit 401 may receive a write request of the value of any component of an array by receiving the request from another computer.

The acquisition unit 401 receives a read request of the value of any component of an array. For example, the read request includes information for identifying any component of the array. For example, the read request includes an index of any component of the array. For example, the acquisition unit 401 receives input of a read request of the value of any component of an array based on the input operation of a user. For example, the acquisition unit 401 may receive a read request of the value of any component of an array by receiving the request from another computer.

The acquisition unit 401 may receive a start trigger for starting the processing of any functional unit. For example, the start trigger is a predetermined input operation of a user. For example, the start trigger may be reception of predetermined information from another computer. For example, the start trigger may be output of predetermined information from any functional unit.

For example, the acquisition unit 401 may receive the reception of the initialization request for the entire plurality of block strings as the start trigger for starting the processing of a change unit. For example, the acquisition unit 401 may receive the reception of the initialization request for any entire block string of the plurality of block strings as the start trigger for starting the processing of the change unit. For example, the acquisition unit 401 may receive the reception of the write request of the value of any component of an array as the start trigger for starting the processing of the storing unit 404. For example, the acquisition unit 401 may receive the reception of the read request of the value of any component of an array as the start trigger for starting the processing of the reading unit 405.

The management unit 402 manages each block string. For example, when there is a front block in the option state in the first half portion of the two portions obtained by dividing a block string, the management unit 402 manages the block string such that the value of a component associated with a rear block in the latter half portion is distributed to and held in the front block. Accordingly, when there is a front block in the option state in the first half portion of a block string, the management unit 402 may set at least a plurality of areas being a part of the last block of the block string as unused areas where the values of components are not stored. When there is no front block in the option state in the first half portion of a block string, the last block of the block string does not include an unused area.

The management unit 402 manages the first area string in which the first areas of the plurality of areas in the last block of each block string are coupled. When there is a front area in the option state in the first half portion of the two portions obtained by dividing the first area string, the management unit 402 manages the first area string such that the values of some components corresponding to a rear area in the latter half portion are distributed to and held in the front area. Accordingly, when there is a front area in the option state in the first half portion of the first area string, the management unit 402 may set at least some areas of the last area of the first area string as unused areas where the values of components are not stored. When there is no front area in the option state in the first half portion of the first area string, the last area of the first area string does not include an unused area.

When there is a front area in the option state in the first half portion of the first area string, the management unit 402 holds, in some areas of the last area of the first area string, a pointer indicating the variable position at which the first area string is divided and an initial value of components for which a value has not been set in the first area string. Accordingly, the management unit 402 may make it easier to initialize the first area string. For example, the management unit 402 may reduce the processing load and processing time taken when the first area string is initialized to O (1). O (⋅) indicates an order.

The management unit 402 holds, for each block string, a pair of a pointer indicating the variable position at which the block string is divided and an initial value of components for which a value has not been set in the block string, by using the second area of the plurality of areas in the last block of each block string. For example, the management unit 402 stores and holds, in the second area of the plurality of areas in the last block of each block string, the pair of a pointer indicating the variable position at which the block string is divided and an initial value of components for which a value has not been set in the block string. Accordingly, the management unit 402 may make it easier to initialize a block string. For example, the management unit 402 may reduce the processing load and processing time taken when a block string is initialized to O (1).

The management unit 402 may also manage the second area string in which the second areas in the last block of each block string are coupled. When there is a front area in the option state in the first half portion of the two portions obtained by dividing the second area string, the management unit 402 manages the second area string such that the pair corresponding to a rear area in the latter half portion is distributed to and held in the front area. Accordingly, when there is a front area in the option state in the first half portion of the second area string, the management unit 402 may set at least some areas of the last area of the second area string as unused areas where the pair is not stored. When there is no front area in the option state in the first half portion of the second area string, the last area of the second area string does not include an unused area where the pair is not stored.

When there is a front area in the option state in the first half portion of the second area string, the management unit 402 holds, in some areas of the last area of the second area string, a pointer indicating the variable position at which the second area string is divided and an initial value of a pair for which a value has not been set in the second area string. Accordingly, the management unit 402 may make it easier to initialize the second area string. For example, the management unit 402 may reduce the processing load and processing time taken when the second area string is initialized to O (1).

By initializing the second area string, the management unit 402 may make it easier to collectively initialize, for each block string, the pair of a pointer indicating the variable position at which the block string is divided and an initial value of components for which a value has not been set in the block string. For this reason, the management unit 402 may make it easier to collectively initialize the entire plurality of block strings.

The management unit 402 determines whether the first area being a part of the last block of each block string is in the option state by using the flag information. When it is determined that the first area being a part of the last block of any block string is in the option state, the management unit 402 treats the block string as a block string in which there is a block in the option state. Accordingly, the management unit 402 does not have to prepare flag information indicating whether there is a block in the option state for each block string, and may achieve reduction of the amount of data used when a plurality of block strings is stored.

When it is determined that the first area being a part of the last block of any block string is not in the option state, the management unit 402 treats the block string as a block string in which there is no block in the option state. Accordingly, the management unit 402 does not have to prepare flag information indicating whether there is a block in the option state for each block string, and may achieve reduction of the amount of data used when a plurality of block strings is stored.

In response to the reception of the initialization request for the entire plurality of block strings, the update unit 403 updates the second area string. For example, the update unit 403 stores, in some areas of the last area of the second area string, a pointer indicating the head of the second area string as the position at which the second area string is divided and the initial value of a pair for which a value has not been set in the second area string. For example, the initial value of a pair indicates a pair of a pointer indicating the head of a block string as the position at which the block string is divided and an initial value of components for which a value has not been set in a block string. Accordingly, the update unit 403 may initialize the second area string. For this reason, the update unit 403 may collectively initialize, for each block string, the pair of a pointer indicating the variable position at which the block string is divided and an initial value of components for which a value has not been set in the block string. The update unit 403 may reduce the processing load and processing time taken when the entire plurality of block strings is initialized to O (1).

In response to the reception of the initialization request for the entire plurality of block strings, the update unit 403 updates the first area string. For example, the update unit 403 stores, in some areas of the last area of the first area string, a pointer indicating the head of the first area string as the position at which the first area string is divided and the initial value of components for which a value has not been set in the first area string. Accordingly, the update unit 403 may initialize the first area string. For this reason, the update unit 403 may appropriately reflect the initialization of the entire plurality of block strings in the first area string.

In response to the reception of the initialization request for the entire plurality of block strings, the update unit 403 updates the flag information. For example, when the flag information is a value indicating that there is no first area in the option state in the first area string, the update unit 403 updates the flag information to a value indicating that there is a first area in the option state. In response to the reception of the initialization request for the entire plurality of block strings, when the flag information is a value indicating that there is a first area in the option state in the first area string, the update unit 403 does not update the flag information. Accordingly, the update unit 403 may appropriately manage the flag information, and may appropriately represent that there is a first area in the option state in the first area string.

In response to the reception of the initialization request for any entire block string of the plurality of block strings, the update unit 403 updates the second area string. For example, the update unit 403 updates the second area corresponding to any block string such that, as the pair corresponding to the second area in the any block string, a pair of a pointer indicating the head of the any block string and an initial value of components for which a value has not been set is set. For example, the second area corresponding to any block string may be the second area in any block string. For example, the second area corresponding to any block string may be a front area in the option state in the first half portion of the second area string.

For example, the update unit 403 may distribute the pair corresponding to the second area in any block string to the front area in the option state in the first half portion of the second area string. For example, the update unit 403 stores and holds all or part of the pair corresponding to the second area in any block string in the front area in the option state in the first half portion of the second area string. Accordingly, the update unit 403 may initialize any block string. For this reason, the update unit 403 may initialize, for any block string, the pair of a pointer indicating the variable position at which the block string is divided and an initial value of components for which a value has not been set in the block string. The update unit 403 may reduce the processing load and processing time taken when any entire block string is initialized to O (1).

In response to the reception of the initialization request for any entire block string, the update unit 403 updates the first area string. For example, the update unit 403 updates the first area string such that the first area of the first area string corresponding to any block string is in the option state. For example, the first area corresponding to any block string may be the first area in any block string. For example, the first area corresponding to any block string may be a front area in the option state in the first half portion of the first area string.

For example, the update unit 403 updates the pointer indicating the position at which the first area string is divided and the initial value of components for which a value has not been set in the first area string, in some areas of the last area of the first area string, such that the first area corresponding to any block string is in the option state. Accordingly, the update unit 403 may appropriately reflect the initialization of any block string in the first area string.

In response to the reception of the initialization request for any entire block string, the update unit 403 updates the flag information. For example, when the flag information is a value indicating that there is no first area in the option state in the first area string, the update unit 403 updates the flag information to a value indicating that there is a first area in the option state. In response to the reception of the initialization request for the entire plurality of block strings, when the flag information is a value indicating that there is a first area in the option state in the first area string, the update unit 403 does not update the flag information. Accordingly, the update unit 403 may appropriately manage the flag information, and may appropriately represent that there is a first area in the option state in the first area string.

In response to the reception of the write request of the value of any component of an array, the storing unit 404 identifies a write destination block corresponding to the any component in a plurality of block strings. The storing unit 404 determines whether the identified write destination block is a block in the option state. When the identified write destination block is not a block in the option state, the storing unit 404 writes the value of any component to the identified write destination block. Accordingly, the storing unit 404 may appropriately process the write request and appropriately store the value of any component.

When the identified write destination block is a block in the option state, the storing unit 404 writes, to the write destination block, the value of any component of a predetermined number of components corresponding to the identified write destination block and an initial value of the remaining components different from any component. The storing unit 404 may update a pointer indicating the position at which the block string including the identified write destination block is divided by updating the second area string such that the write destination block is in the value state. Accordingly, the storing unit 404 may appropriately process the write request and appropriately store the value of any component.

In response to the reception of the read request of the value of any component of an array, the reading unit 405 identifies a read source block corresponding to the any component in a plurality of block strings. The reading unit 405 determines whether the identified read source block is a block in the option state. When the identified read source block is not a block in the option state, the reading unit 405 reads the value of any component from the identified read source block. Accordingly, the reading unit 405 may appropriately process the read request and appropriately read the value of any component.

When the identified read source block is a block in the option state, the reading unit 405 determines whether the second area corresponding to the identified read source block is a second area in the option state. When the second area is a second area in the option state, the reading unit 405 reads the initial value of any component from some areas of the last area of the second area string. Accordingly, the reading unit 405 may appropriately process the read request and appropriately read the value of any component.

When the second area corresponding to the identified read source block is not a second area in the option state, the reading unit 405 reads the initial value of any component from the second area corresponding to the identified read source block. Accordingly, the reading unit 405 may appropriately process the read request and appropriately read the value of any component.

The output unit 406 outputs a processing result of at least any functional unit. For example, the form of output is display on a display, output to a printer for printing, transmission to an external apparatus through the network I/F 303, or storage in the storage area such as the memory 302 or the recording medium 305. Accordingly, the output unit 406 may enable a user to be notified of a processing result of at least any functional unit, and achieve improvement in the convenience of the information processing apparatus 100.

The output unit 406 outputs the fact that the entire plurality of block strings has been successfully initialized in response to the reception of the initialization request for the entire plurality of block strings. For example, the output unit 406 outputs the fact that the entire plurality of block strings has been successfully initialized in response to the reception of the initialization request for the entire plurality of block strings, so that a user may refer to the fact. Accordingly, the output unit 406 may enable reference to the fact that the entire plurality of block strings has been successfully initialized in response to the reception of the initialization request for the entire plurality of block strings.

The output unit 406 outputs the fact that any entire block string of the plurality of block strings has been successfully initialized in response to the reception of the initialization request for any entire block string of the plurality of block strings. For example, the output unit 406 outputs the fact that any entire block string of the plurality of block strings has been successfully initialized in response to the reception of the initialization request for any entire block string of the plurality of block strings, so that a user may refer to the fact. Accordingly, the output unit 406 may enable reference to the fact that any entire block string of the plurality of block strings has been successfully initialized in response to the reception of the initialization request for any entire block string of the plurality of block strings.

The output unit 406 outputs the fact that the value of any component of an array has been successfully written in response to the write request. For example, the output unit 406 outputs the fact that the value of any component of an array has been successfully written in response to the write request so that a user may refer to the fact. Accordingly, the output unit 406 may enable reference to the fact that the value of any component of an array has been successfully written in response to the write request.

The output unit 406 outputs the value of any component of an array that has been read in response to the read request. For example, the output unit 406 outputs the value of any component of an array that has been read in response to the read request so that a user may refer to the value. Accordingly, the output unit 406 may enable the use of the value of any component of an array.

### Example of Operation of Information Processing Apparatus 100

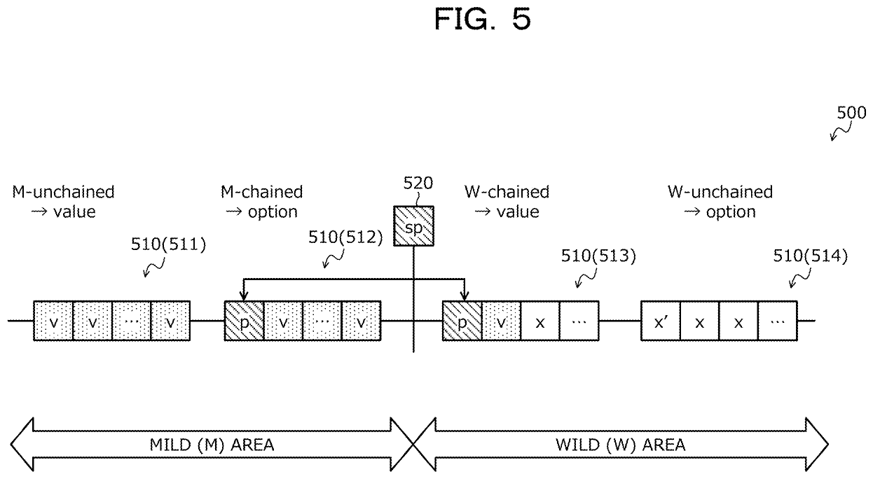

Next, an example of the operation of the information processing apparatus 100 will be described with reference to FIGS. 5 to 7. For example, first, an example of a data structure of a block string 500 stored in the information processing apparatus 100 will be described with reference to FIG. 5. For example, the data structure of the block string 500 is the data structure called optimal space initializable array.

FIG. 5 is an explanatory diagram illustrating an example of the data structure of the block string 500. As illustrated in FIG. 5, for example, the block string 500 is formed by connecting a plurality of blocks 510 each associated with a predetermined number of components of an array. For example, the block string 500 represents an array.

For example, the block string 500 is divided into two front and rear portions. For example, the position at which the block string 500 is divided is indicated by a stack pointer 520. For example, the position at which the block string 500 is divided is variable. In the following description, there are cases where the first half portion of the two portions obtained by dividing the block string 500 is referred to as the “mild (M) area”. In the following description, there are cases where the latter half portion of the two portions obtained by dividing the block string 500 is referred to as the “wild (W) area”.

The block 510 includes a predetermined number of areas. For example, an area may store the value of a component. For example, an area may be capable of storing a pointer p to any block 510. For example, the block 510 is in one of the value state and the option state. For example, the block 510 is in the option state when none of the values of the predetermined number of components associated with the block 510 have been set. For example, the values of the predetermined number of components associated with the block 510 in the option state are treated as the set initial value. For example, the block 510 is in the value state when the value of at least any component associated with the block 510 has been set.

For example, a block 511 in the value state in the M area stores the value v of at least any component associated with the block 511 itself. For example, the block 511 in the value state in the M area stores the set initial value for the value of a component whose value has not been set among the predetermined number of components associated with the block 511. In the example of FIG. 5, for example, the block 511 in the value state in the M area stores the value of each component of the predetermined number of components associated with the block 511 in each area of the predetermined number of areas of the block 511.

For example, a block 512 in the option state in the M area is the distribution destination to which the values of (predetermined number−1) components from the first component are distributed among the predetermined number of components associated with a block 513 in the value state in the W area. For example, the block 512 in the option state in the M area stores, in the head area of the predetermined number of areas of the block 512, a pointer to the block 513 in the value state in the W area being the distribution source of distributing the values of (predetermined number−1) components. For example, the block 512 in the option state in the M area stores the value of each component of the above-described (predetermined number−1) components in the remaining areas of the predetermined number of areas of the block 512 other than the head area.

For example, the block 513 in the value state in the W area is the distribution source of distributing, to the block 512 in the option state in the M area, the values of (predetermined number−1) components from the first component among the predetermined number of components associated with the block 513. For example, the block 513 in the value state in the W area stores, in the head area of the predetermined number of areas of the block 513, a pointer to the block 512 in the option state in the M area being the distribution destination to which the values of (predetermined number−1) components are distributed. For example, the block 513 in the value state in the W area stores the value of the last component of the predetermined number of components associated with the block 513, in the second area from the head area of the predetermined number of areas of the block 513.

For example, the values of components are not stored in a block 514 in the option state in the W area. For example, the block 514 in the option state in the W area stores an arbitrary value x′ that is not a pointer to any of the blocks 510 in the head area of the predetermined number of areas of the block 514. For example, the block 514 in the option state of the W area stores the arbitrary value x in the remaining areas of the predetermined number of areas of the block 514 other than the head area.

Every time the value of a component of an array is set, the block string 500 is updated. For example, in response to the value of a component of an array having been set, the position indicated by the stack pointer 520 for the block string 500 may be updated, and the M area and the W area may be updated. For example, in response to the value of a component of an array having been set, the state of the block 510 may be updated to the value state or the option state.

Until immediately before the values of all components of an array are set, the last block 510 of the block string 500 is in one of the value state in the W area and the option state in the W area. For this reason, until immediately before the values of all components of an array are set, (predetermined number—2) areas of the predetermined number of areas of the last block 510 of the block string 500 excluding the first two areas are areas in which the values of components are not stored. Until immediately before the values of all components of an array are set, a pointer to another block 510 and the value of one component may be stored in the first two areas of the predetermined number of areas of the last block 510 of the block string 500.

For example, until immediately before the values of all components of an array are set, the stack pointer 520 for the block string 500 is stored in (predetermined number−2) areas of the predetermined number of areas of the last block 510 of the block string 500 excluding the first two areas. For example, until immediately before the values of all components of an array are set, the initial value for the values of the predetermined number of components associated with the block 510 in the option state is stored in the above-described (predetermined number−2) areas of the predetermined number of areas of the last block 510 of the block string 500.

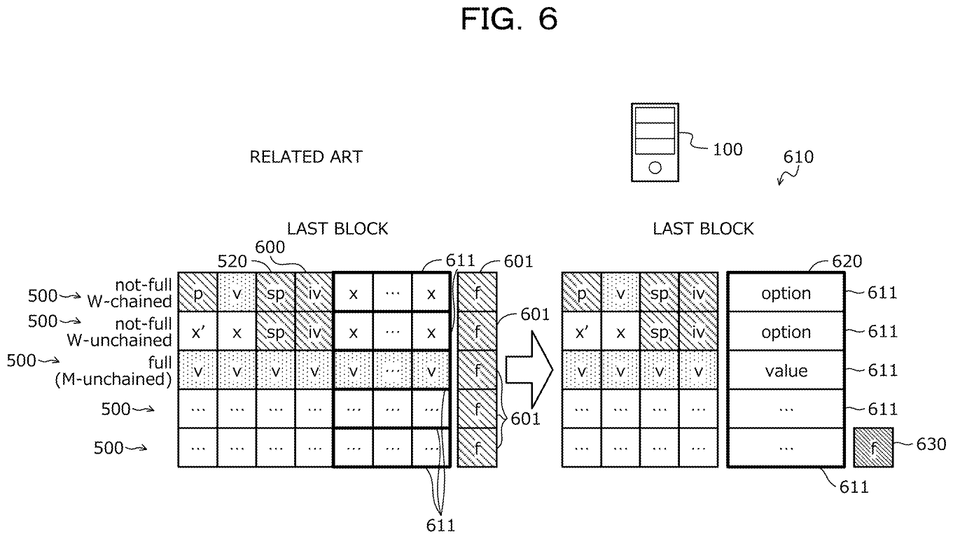

For example, the information processing apparatus 100 stores a plurality of arrays by storing a plurality of block strings 500 representing different arrays. Next, a first example in which the information processing apparatus 100 stores the plurality of block strings 500 will be described with reference to FIG. 6.

FIG. 6 is an explanatory diagram illustrating the first example in which the plurality of block strings 500 is stored. When the values of all components of an array have been set, an area in which the value of a component is not stored does not exist in the predetermined number of areas of the last block 510 of the block string 500. For example, when the values of all components of an array have been set, all of the predetermined number of areas of the last block 510 of the block string 500 store the values of components.

Accordingly, when the values of all components of an array have been set, the stack pointer 520 for the block string 500 may not be stored in the last block 510 of the block string 500. In this case, the W area does not exist.

For the above situation, a method is conceivable in which flag information 601 is prepared in association with each block string 500, the flag information indicating whether the values of all components of an array have been set and the block string 500 is in the full state. For example, the value 1 of the flag information 601 indicates that there is no block 510 in the option state and that the block string 500 is in the full state. For example, the value 0 of the flag information 601 indicates that there is the block 510 in the option state and that the block string 500 is in the not-full state.

For example, this method enables determination of, for each block string 500, whether there is the stack pointer 520 for the block string 500 in the last block 510 of the block string 500 by the flag information 601 associated with the block string 500, as shown in left side of FIG. 6. However, this method has a problem that an increase in the amount of data is caused when the plurality of block strings 500 representing different arrays is stored. For example, in this method, as the number of arrays increases and the number of block strings 500 stored in the information processing apparatus 100 increases, an increase in the number of pieces of flag information 601 to be prepared is caused and an increase in the amount of data is caused.

The information processing apparatus 100 manages, as shown in in right side of FIG. 6, as a last area string 620 in which last areas 611 are coupled, less than (predetermined number−2) last areas 611 in the last block 510 of each block string 500 in which the value of a component is not stored. For example, the last area 611 does not include an area that stores the stack pointer 520 for the block string 500 in the predetermined number of areas of the last block 510. For example, the last area 611 may include the area that stores the stack pointer 520 in the predetermined number of areas of the last block 510.

For example, the last area 611 does not include an area that stores an initial value 600 for the values of the predetermined number of components associated with the block 510 in the option state in the predetermined number of areas of the last block 510. For example, the last area 611 may include the area that stores the initial value 600 for the values of the predetermined number of components associated with the block 510 in the option state in the predetermined number of areas of the last block 510.

For example, the last area 611 includes less than (predetermined number−2) areas. For example, an area may store the value of a component. For example, an area may be capable of storing a pointer to any last area 611. In the following description, for example, the last area 611 does not include the area that stores the stack pointer 520 for the block string 500 and the area that stores the initial value 600 for the values of the predetermined number of components associated with the block 510 in the option state. Accordingly, in the following description, for example, the last area 611 includes (predetermined number−4) areas. For example, the information processing apparatus 100 manages the last area string 620 as the data structure called optimal space initializable array.

As in the case of the block string 500, for example, the last area string 620 is divided into two front and rear portions. For example, the position at which the last area string 620 is divided is indicated by a stack pointer. For example, the position at which the last area string 620 is divided is variable. In the following description, as in the case of the block string 500, there are cases where the first half portion of the two portions obtained by dividing the last area string 620 is referred to as the “mild (M) area”. In the following description, as in the case of the block string 500, there are cases where the latter half portion of the two portions obtained by dividing the last area string 620 is referred to as the “wild (W) area”.

For example, the last area 611 is in one of the value state and the option state. For example, the last area 611 is in the option state when none of the values of the components associated with the last area 611 are stored. For example, the last area 611 is in the option state when the block string 500 including the last area 611 is in the not-full state. For example, the values of the predetermined number of components associated with the last area 611 in the option state may be treated as the initial value set for the last area 611.

For example, the last area 611 is in the value state when the value of at least any component associated with the last area 611 is stored. For example, the last area 611 is in the value state when the block string 500 including the last area 611 is in the full state. As described above, the state of the last area 611 may be used as information indicating whether the block string 500 including the last area 611 is in the full state or the not-full state.

For example, the last area 611 in the value state in the M area stores the value v of at least any component associated with the last area 611 itself. For example, the last area 611 in the value state in the M area stores the set initial value for the value of a component for which a value has not been set among the components associated with the last area 611.

For example, the last area 611 in the option state in the M area is the distribution destination to which the values of the components associated with the last area 611 in the value state in the W area are distributed. For example, the last area 611 in the option state in the M area stores, in the head area of the (predetermined number−4) areas of the last area 611, a pointer to the last area 611 in the value state in the W area being the distribution source of distributing the values of components. For example, the last area 611 in the option state in the M area stores the above-described values of components in the remaining areas of the (predetermined number−4) areas of the last area 611 other than the head area.

For example, the last area 611 in the value state in the W area is the distribution source of distributing the values of the components associated with the last area 611 to the last area 611 in the option state in the M area. For example, the last area 611 in the value state in the W area stores, in the head area of the (predetermined number−4) areas of the last area 611, a pointer to the last area 611 in the option state in the M area being the distribution destination to which the values of components are distributed. For example, the last area 611 in the value state in the W area stores the value of the last component of the components associated with the last area 611 in the second area from the head area of the (predetermined number−4) areas of the last area 611.

For example, the values of components are not stored in the last area 611 in the option state in the W area. For example, the last area 611 in the option state in the W area stores an arbitrary value that is not a pointer to any of the last areas 611 in the head area of the (predetermined number−4) areas of the last area 611. For example, the last area 611 in the option state in the W area stores the arbitrary value in the remaining areas of the (predetermined number−4) areas of the last area 611 other than the head area.

Every time the value of a component associated with the last block 510 of any block string 500 is set, the last area string 620 is updated. For example, in response to the value of a component having been set, the position indicated by the stack pointer for the last area string 620 may be updated, and the M area and the W area may be updated. For example, in response to the value of a component having been set, the state of the last area 611 may be updated to the value state or the option state.

Until immediately before the values of all components associated with the last area string 620 are set, the last area 611 at the end of the last area string 620 is in one of the value state in the W area and the option state in the W area. For this reason, until immediately before the values of all components associated with the last area string 620 are set, the remaining areas of the last area 611 at the end of the last area string 620 excluding the first two areas are areas in which the values of components are not set.

For example, until immediately before the values of all components associated with the last area string 620 are set, the stack pointer for the last area string 620 is stored in the above-described remaining areas of the last area 611 at the end of the last area string 620. For example, until immediately before the values of all components associated with the last area string 620 are set, the initial value for the values of the components associated with the last area 611 in the option state is stored in the above-described remaining areas in the last area string 620.

When the values of all components of an array indicated by each block string 500 have been set, an area in which the value of a component is not set does not exist in the plurality of block strings 500. For example, when the values of all components of an array indicated by each block string 500 have been set, the last area 611 in the option state does not exist in the last area string 620. For this reason, the last area 611 at the end of the last area string 620 does not include an area in which the value of a component is not stored. Accordingly, when the values of all components of an array indicated by each block string 500 have been set, the stack pointer for the last area string 620 may not be stored in the last area 611 at the end of the last area string 620. In this case, the W area does not exist.

Accordingly, the information processing apparatus 100 stores flag information 630 indicating whether the last area string 620 does not include the last area 611 in the option state and the last area string 620 is in the full state. For example, the value 1 of the flag information 630 indicates that there is no last area 611 in the option state and that the last area string 620 is in the full state. For example, the value 0 of the flag information 630 indicates that there is the last area 611 in the option state and that the last area string 620 is in the not-full state.

Accordingly, the information processing apparatus 100 may manage whether the block string 500 including the last area 611 is in the full state according to the state of the last area 611 without preparing the flag information 601 in association with each block string 500. The information processing apparatus 100 may manage whether the last area string 620 is in the full state based on the flag information 630.

Accordingly, the information processing apparatus 100 may achieve reduction of the amount of data used when the plurality of block strings 500 is stored, as compared with the above method of preparing the flag information 601 in association with each block string 500. For example, in the above method of preparing the flag information 601 in association with each block string 500, the amount of data used when the plurality of block strings 500 is stored is O (M). M is the number of block strings (=the number of arrays). By contrast, the information processing apparatus 100 may reduce the amount of data used when the plurality of block strings 500 is stored to O (1).

In the first example described above, when the entire plurality of block strings 500 is initialized, the information processing apparatus 100 updates, for each block string 500, a pair of the stack pointer 520 and the initial value 600 in the last block 510 of the block string 500. For this reason, the processing load and processing time taken when the entire plurality of block strings 500 is initialized are considered to be O (M).

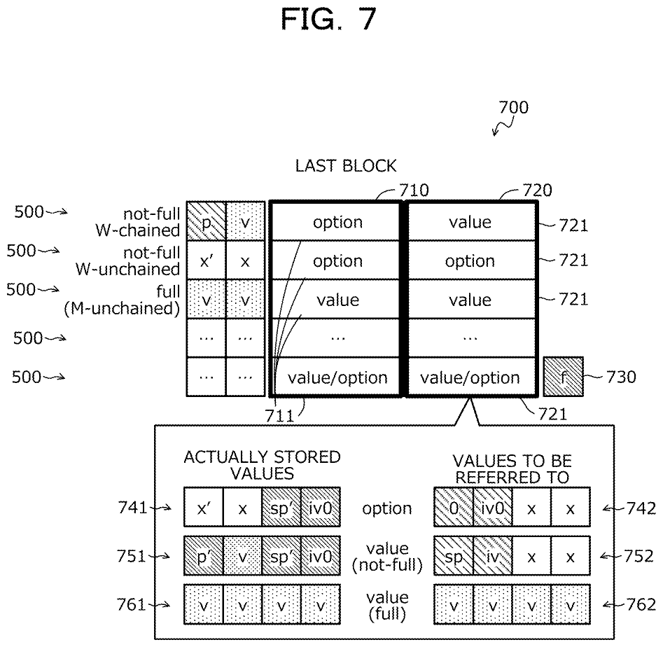

By comparison, a second example will be described in which the information processing apparatus 100 stores the plurality of block strings 500 such that the processing load and processing time taken when the entire plurality of block strings 500 is initialized are reduced to O (1). For example, the second example in which the information processing apparatus 100 stores the plurality of block strings 500 will be described with reference to FIG. 7.

FIG. 7 is an explanatory diagram illustrating the second example in which the plurality of block strings 500 is stored. The information processing apparatus 100 divides (predetermined number−2) last areas in the last block 510 of each block string 500 in which the values of components are not stored, into a first area 711 and a second area 721.

For example, the first area 711 does not include the area that stores the stack pointer 520 for the block string 500 in the predetermined number of areas of the last block 510. For example, the first area 711 does not include the area that stores the initial value 600 for the values of the predetermined number of components associated with the block 510 in the option state in the predetermined number of areas of the last block 510. The second area 721 includes at least two areas.

The information processing apparatus 100 manages the first area 711 in the last block 510 of each block string 500 as a first area string 710 in which the first areas 711 are coupled. The first area string 710 is similar to the last area string 620. For example, the information processing apparatus 100 manages the first area string 710 as the data structure called optimal space initializable array.

On the other hand, the information processing apparatus 100 manages the second area 721 in the last block 510 of each block string 500 as a second area string 720 in which the second areas 721 are coupled. For example, the information processing apparatus 100 manages the second area string 720 as the data structure called optimal space initializable array.

For example, the second area 721 includes the area that stores the stack pointer 520 in the predetermined number of areas of the last block 510. For example, the second area 721 includes the area that stores the initial value 600 for the values of the predetermined number of components associated with the block 510 in the option state in the predetermined number of areas of the last block 510.

In the following description, for example, the second area 721 includes four areas. For example, an area may store the stack pointer 520 for the block string 500. For example, an area may store the initial value 600 for the values of the predetermined number of components associated with the block 510 in the option state. For example, an area may store the value of a component.

As in the case of the block string 500, for example, the second area string 720 is divided into two front and rear portions. For example, the position at which the second area string 720 is divided is indicated by a stack pointer. For example, the position at which the second area string 720 is divided is variable. In the following description, as in the case of the block string 500, there are cases where the first half portion of the two portions obtained by dividing the second area string 720 is referred to as the “mild (M) area”. In the following description, as in the case of the block string 500, there are cases where the latter half portion of the two portions obtained by dividing the second area string 720 is referred to as the “wild (W) area”.

For example, the second area 721 is in one of the value state and the option state. For example, the second area 721 is in the option state when the values of the components associated with the second area 721 are not stored and the pair of the stack pointer 520 and the initial value 600 is not stored. For example, the second area 721 is in the option state when the block string 500 including the second area 721 is in the initial state. When the second area 721 is in the option state, the pair of the stack pointer for the block string 500 including the second area 721 and the initial value 600 is treated as the set initial pair.

For example, the second area 721 is in the value state when the values of the components associated with the second area 721 are stored. For example, the second area 721 is in the value state when the block string 500 including the second area 721 is in the full state. When the block string 500 is in the full state, the first area 711 of the block string is in the value state. Accordingly, in a case where the first area 711 of the block string 500 including the second area 721 is in the value state, when the second area 721 is also in the value state, the second area 721 is treated as storing the values of the components associated with the second area 721.

On the other hand, for example, the second area 721 is also in the value state when the pair of the stack pointer 520 and the initial value 600 is stored. For example, the second area 721 is in the value state when the block string 500 including the second area 721 is in the not-full state. When the block string 500 is in the not-full state, the first area 711 of the block string is in the option state. Accordingly, in a case where the first area 711 of the block string 500 including the second area 721 is in the option state, when the second area 721 is in the value state, the second area 721 is treated as storing the pair of the stack pointer 520 and the initial value 600.

As described above, a combination of the state of the first area 711 and the state of the second area 721 indicates whether the second area 721 is empty, stores the values of components, or stores the pair of the stack pointer 520 and the initial value 600.

For example, there is a case where the second area 721 in the value state in the M area stores the value v of at least any component associated with the second area 721 itself. In this case, for example, the second area 721 in the value state in the M area stores the set initial value for the value of a component for which a value has not been set among the components associated with the second area 721. For example, there is also a case where the second area 721 in the value state in the M area stores the pair of the stack pointer 520 and the initial value 600.

For example, there is a case where the second area 721 in the option state in the M area is the distribution destination to which the values of the components associated with the second area 721 in the value state in the W area are distributed. In this case, for example, the second area 721 in the option state in the M area stores, in the head area of the second area 721, a pointer to the second area 721 in the value state in the W area being the distribution source. In this case, for example, the second area 721 in the option state in the M area stores the above-described values of components in the remaining areas of the second area 721 other than the head area.

For example, there is also a case where the second area 721 in the option state in the M area is the distribution destination to which the pair of the stack pointer 520 for the block string 500 including the second area 721 in the value state in the W area and the initial value 600 is distributed. In this case, for example, the second area 721 in the option state in the M area stores, in the head area of the second area 721, a pointer to the second area 721 in the value state in the W area being the distribution source. In this case, for example, the second area 721 in the option state in the M area stores the above-described pair of the stack pointer 520 and the initial value 600 in the remaining areas of the second area 721 other than the head area.

For example, there is a case where the second area 721 in the value state in the W area is the distribution source of distributing the values of the components associated with the second area 721 to the second area 721 in the option state in the M area. In this case, for example, the second area 721 in the value state in the W area stores, in the head area of the second area 721, a pointer to the second area 721 in the option state in the M area being the distribution destination to which the values of components are distributed. In this case, for example, the second area 721 in the value state in the W area stores the value of the last component of the components associated with the second area 721 in the second area from the head area of the second area 721.

For example, there is a case where the second area 721 in the value state in the W area is the distribution source of distributing the pair of the stack pointer 520 for the block string 500 including the second area 721 and the initial value 600 to the second area 721 in the option state in the M area. In this case, for example, the second area 721 in the value state in the W area stores, in the head area of the second area 721, a pointer to the second area 721 in the option state in the M area being the distribution destination. In this case, for example, the second area 721 in the value state in the W area may empty the remaining areas of the second area 721 other than the head area.

For example, the values of components are not stored in the second area 721 in the option state in the W area. For example, the second area 721 in the option state in the W area does not store the pair of the stack pointer 520 for the block string 500 including the second area 721 and the initial value 600. For example, the second area 721 in the option state in the W area stores an arbitrary value that is not a pointer to any of the second areas 721 in the head area of the second area 721. For example, the second area 721 in the option state in the W area stores the arbitrary value in the remaining areas of the second area 721 other than the head area.

Every time the value of a component associated with the last block 510 of any block string 500 is set, the second area string 720 is updated. For example, in response to the value of a component having been set, the position indicated by the stack pointer for the second area string 720 may be updated, and the M area and the W area may be updated. For example, in response to the value of a component having been set, the state of the second area 721 may be updated to the value state or the option state.

Every time the pair of the stack pointer 520 for any block string 500 and the initial value 600 is set or updated, the second area string 720 is updated. For example, in response to the pair of the stack pointer 520 and the initial value 600 having been set, the position indicated by the stack pointer for the second area string 720 may be updated, and the M area and the W area may be updated. For example, in response to the pair of the stack pointer 520 and the initial value 600 having been set, the state of the second area 721 may be updated to the value state or the option state.

Until immediately before all of the second areas 721 are in the value state in the M area, the second area 721 at the end of the second area string 720 is in one of the value state in the W area or the option state in the W area. For this reason, until immediately before all of the second areas 721 are in the value state in the M area, the remaining areas of the second area 721 at the end of the second area string 720 excluding the first two areas are empty areas.

For example, until immediately before all of the second areas 721 are in the value state in the M area, the stack pointer for the second area string 720 is stored in the above-described remaining areas of the second area 721 at the end of the second area string 720. For example, until immediately before all of the second areas 721 are in the value state in the M area, an initial pair for the pair of the stack pointer 520 for the block string 500 and the initial value 600 is stored in the above-described remaining areas of the second area 721 at the end.

When the values of all components of an array indicated by each block string 500 have been set, an area in which the value of a component is not set does not exist in the plurality of block strings 500. For example, when the values of all components of an array indicated by each block string 500 have been set, the last area 611 in the option state does not exist in the first area string 710. For this reason, the first area 711 at the end of the first area string 710 does not include an area in which the value of a component is not stored. Accordingly, when the values of all components of an array indicated by each block string 500 have been set, the stack pointer for the first area string 710 may not be stored in the first area 711 at the end of the first area string 710. In this case, the W area does not exist.

Accordingly, the information processing apparatus 100 stores flag information 730 indicating whether the first area string 710 does not include the last area 611 in the option state and the first area string 710 is in the full state. For example, the value 1 of the flag information 730 indicates that there is no first area 711 in the option state and that the first area string 710 is in the full state. For example, the value 0 of the flag information 730 indicates that there is the first area 711 in the option state and that the first area string 710 is in the not-full state.

Accordingly, the information processing apparatus 100 may manage whether the block string 500 including the first area 711 is in the full state according to the state of the first area 711 without preparing the flag information 601 in association with each block string 500. The information processing apparatus 100 may manage whether the first area string 710 is in the full state based on the flag information 730.

Accordingly, the information processing apparatus 100 may achieve reduction of the amount of data used when the plurality of block strings 500 is stored, as compared with the above method of preparing the flag information 601 in association with each block string 500. For example, in the above method of preparing the flag information 601 in association with each block string 500, the amount of data used when the plurality of block strings 500 is stored is O (M). M is the number of block strings (=the number of arrays). By contrast, the information processing apparatus 100 may reduce the amount of data used when the plurality of block strings 500 is stored to O (1).

When the second area 721 of the block string 500 is in the value state, the information processing apparatus 100 may manage the type of information stored in the second area 721 according to the state of the first area 711 of the block string 500. For example, when the first area 711 is in the option state in the case where the second area 721 is in the value state, the information processing apparatus 100 may determine that the second area 721 stores the pair of the stack pointer 520 and the initial value 600. On the other hand, for example, when the first area 711 is in the value state in the case where the second area 721 is in the value state, the information processing apparatus 100 may determine that the second area 721 stores the value of a component.

For example, when the contents of any second area 721 in the option state are actually the contents indicated by reference sign 741, the information processing apparatus 100 recognizes that the any second area 721 presents the contents indicated by reference sign 742. For example, when any second area 721 is in the option state, the information processing apparatus 100 recognizes that the any second area 721 presents the initial pair that has been stored in the second area 721 at the end. The initial pair is a pair of the stack pointer=0 indicating the head of the block string 500 and the initial value iv0 for the values of the predetermined number of components associated with the block 510 in the option state of the block string 500.

For example, a case may be considered in which, since the first area 711 is in the option state, the block string 500 including the first area 711 is in the not-full state, and any second area 721 of the block string 500 is in the value state. For example, any second area 721 in this case is the second area 721 at the end. In this case, for example, when the contents of any second area 721 are actually the contents indicated by reference sign 751, the information processing apparatus 100 recognizes that the any second area 721 presents the contents indicated by reference sign 752. For example, the information processing apparatus 100 recognizes that any second area 721 presents a pair of the stack pointer sp and the initial value iv, which has been stored in another second area 721 indicated by the pointer p stored in the head area of the any second area 721.

For example, a case may be considered in which, since the first area 711 is in the value state, the block string 500 including the first area 711 is in the full state, and any second area 721 of the block string 500 is in the value state. In this case, for example, when the contents of any second area 721 are actually the contents indicated by reference sign 761, the information processing apparatus 100 recognizes that the any second area 721 presents the contents indicated by reference sign 762. The contents indicated by reference sign 762 are the same as the contents indicated by reference sign 761. For example, the information processing apparatus 100 recognizes that the contents of any second area 721 are the contents indicated by reference sign 761 themselves.

The information processing apparatus 100 may collectively update the pair of the stack pointer 520 for each block string 500 and the initial value 600 to the initial pair by initializing the second area string 720. For example, the information processing apparatus 100 may initialize the second area string 720 by initializing the stack pointer for the second area string 720 and the initial pair in the second area 721 at the end of the second area string 720. For this reason, the information processing apparatus 100 may reduce the processing load and processing time taken when the entire plurality of block strings 500 is initialized to O (1).

### Example of Application of Information Processing Apparatus 100

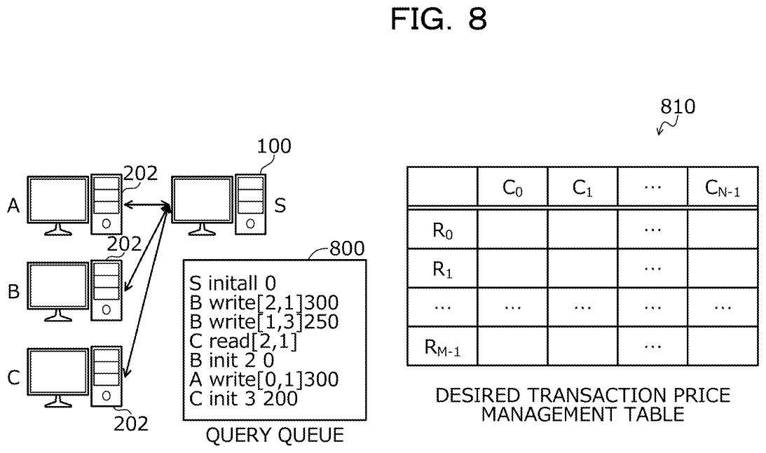

Next, an example of application of the information processing apparatus 100 will be described with reference to FIGS. 8 to 17.

FIGS. 8 to 17 are explanatory diagrams illustrating an example of application of the information processing apparatus 100. In FIG. 8, a case will be described in which the information processing apparatus 100 is applied to management of desired transaction prices of N commodities Cⱼ commonly manufactured by M users Rᵢ as illustrated in table 810. For example, i is 0 to M−1. For example, j is 0 to N−1. In the example of FIG. 8, M=4 and N=400. For example, users Rᵢ include user A, user B, user C, and the like. For example, user Rᵢ has the client apparatus 202. For example, user Rᵢ is a manufacturer, a vendor, or the like.

For each user Rᵢ, the information processing apparatus 100 stores, as a block string, an array including the desired transaction prices of N commodities Cⱼ as components. For example, the information processing apparatus 100 stores four block strings indicating different arrays including, as components, the desired transaction prices of N commodities Cⱼ for different users Rᵢ. For example, a block includes areas capable of storing 100 components. For example, a block string includes four blocks.

The information processing apparatus 100 sequentially receives various queries indicated in a query queue 800 at a first time point. For example, the information processing apparatus 100 receives a query from user Rᵢ via the client apparatus 202. For example, the information processing apparatus 100 may receive a query by receiving input of the query via an input device (not illustrated).

For example, a query is an entire initialization request (initall) that requests initialization of the entire plurality of block strings. For example, a query is a row initialization request (init) that requests initialization of any block string. For example, a query is a write request (write) that requests storage of the value of any component in any block string. For example, a query is a read request (read) that requests reading of the value of any component from any block string. In the following description, a specific example will be described in which the information processing apparatus 100 sequentially processes the various queries indicated in the query queue 800.

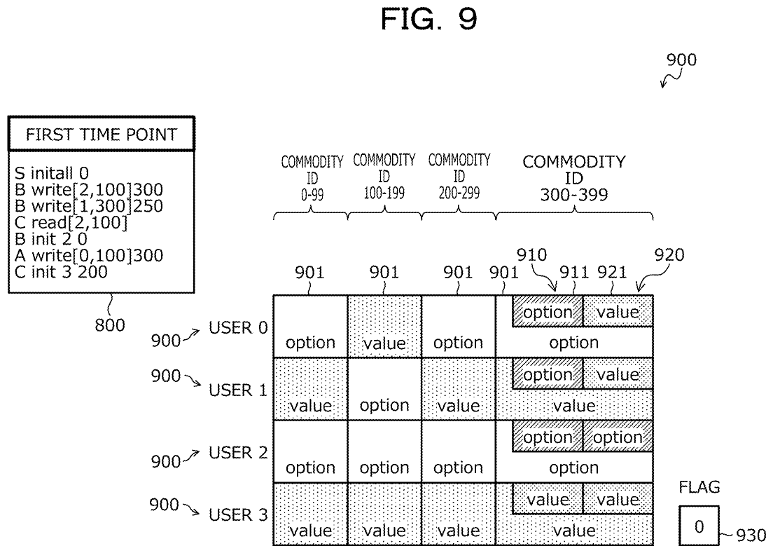

First, description will be given with reference to FIG. 9, and description will be given for the state of four block strings 900 at the first time point in a case where the information processing apparatus 100 stores the four block strings 900 with the data structure similar to that in the second example described above. As illustrated in FIG. 9, the information processing apparatus 100 stores four block strings 900. For example, a block 901 is associated with 100 components. The block 901 includes areas capable of storing the values of 100 components.

The last block 901 of the block string 900 includes a first area 911 and a second area 921. The information processing apparatus 100 treats the first area 911 in the last block 901 of each block string 900 as a part of a first area string 910 in which the first areas 911 are coupled. The information processing apparatus 100 treats the second area 921 in the last block 901 of each block string 900 as a part of a second area string 920 in which the second areas 921 are coupled.

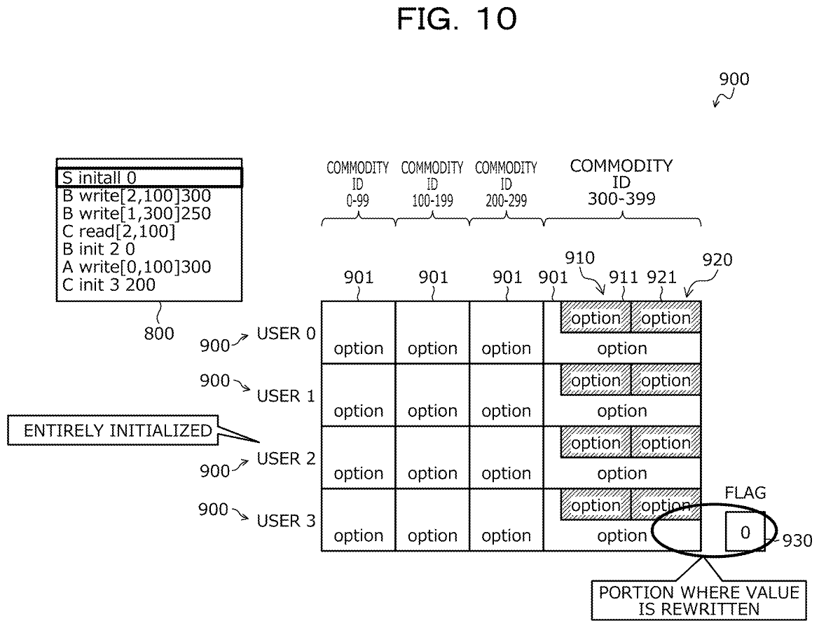

The information processing apparatus 100 stores flag information 930 indicating whether there is the first area 911 in the option state in the first area string 910 and whether the first area string 910 is in the not-full state. The flag information 930 is a value of 0 or 1. The value 0 of the flag information 930 indicates that the first area string 910 is in the not-full state. The value 1 of the flag information 930 indicates that the first area string 910 is in the full state instead of the not-full state. Next, description will be given with reference to FIG. 10.

In FIG. 10, the information processing apparatus 100 extracts the entire initialization request “S initall 0” from the query queue 800 and processes the request. In this case, the information processing apparatus 100 initializes the entire first area string 910 by storing a pair of the stack pointer=0 for the first area string 910 and an initial value in the first area 911 at the end of the first area string 910.

The information processing apparatus 100 initializes the entire second area string 920 by storing a pair of the stack pointer=0 for the second area string 920 and an initial pair in the second area 921 at the end of the second area string 920. The information processing apparatus 100 sets 0 as the flag information 930 since the first area string 910 is in the not-full state.

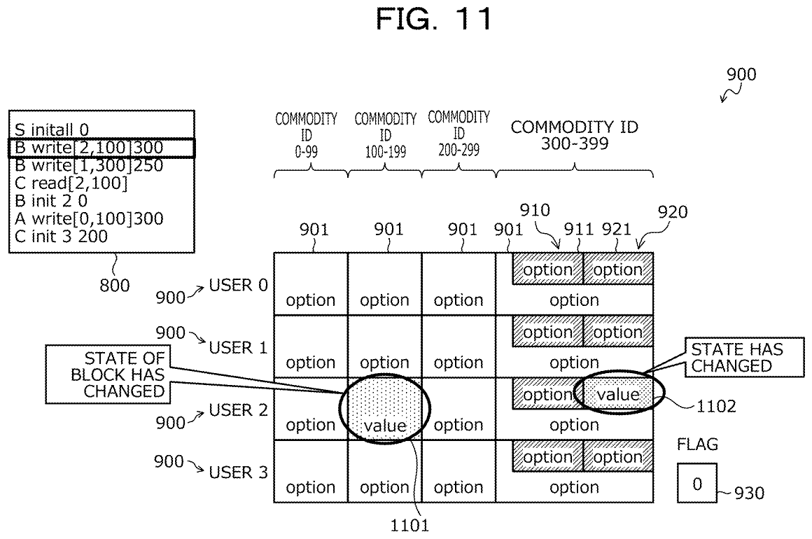

Accordingly, the information processing apparatus 100 may appropriately process the entire initialization request “S initall 0”, and may initialize the entire plurality of block strings 900. The information processing apparatus 100 may reduce the processing load and processing time taken when the entire plurality of block strings 900 is initialized to O (1). Next, description will be given with reference to FIG. 11.

In FIG. 11, the information processing apparatus 100 extracts the write request “B write[2,100]300” from the query queue 800 and processes the request. write[a,b]c indicates that the value=c of the component having the commodity id=b is stored in the block string 900 corresponding to user Rₐ.

In this case, the information processing apparatus 100 identifies the block 901 (1101) associated with the component having the commodity id=100 in the block string 900 corresponding to user R₂. The information processing apparatus 100 updates the second area string 920 such that the second area 921 (1102) at the end of the block string 900 corresponding to user R₂ is a value area.

The information processing apparatus 100 stores a pair of the stack pointer for the block string 900 corresponding to user R₂ and an initial value in the second area string 920 such that the identified block 901 (1101) is in the value state. The information processing apparatus 100 stores the value=300 of the component having the commodity id=100 in the identified block 901 (1101). When the identified block 901 (1101) is the block 901 that has been in the option state up to this point, the information processing apparatus 100 may store (the value of another component other than the component having the commodity id=100)=initial value in the identified block 901 (1101).

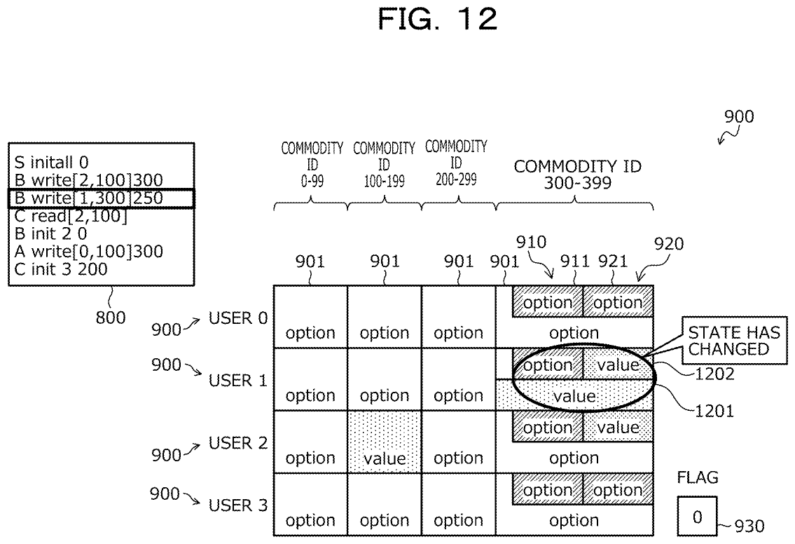

Accordingly, the information processing apparatus 100 may appropriately process the write request “B write[2,100]300”, and may store the value=300 of the component having the commodity id=100 in the block string 900 corresponding to user R₂. The information processing apparatus 100 may reduce the processing load and processing time taken when the write request is processed to O (1). Next, description will be given with reference to FIG. 12.

In FIG. 12, the information processing apparatus 100 extracts the write request “B write[1,300]250” from the query queue 800 and processes the request. In this case, the information processing apparatus 100 identifies the block 901 (1201) associated with the component having the commodity id=300 in the block string 900 corresponding to user R₁. The information processing apparatus 100 updates the second area string 920 such that the second area 921 (1202) at the end of the block string 900 corresponding to user R₁ is a value area.

The information processing apparatus 100 stores a pair of the stack pointer for the block string 900 corresponding to user R₁ and an initial value in the second area string 920 such that the identified block 901 (1201) is in the value state. The information processing apparatus 100 stores the value=250 of the component having the commodity id=300 in the identified block 901 (1201). When the identified block 901 (1201) is the block 901 that has been in the option state up to this point, the information processing apparatus 100 may store (the value of another component other than the component having the commodity id=300)=initial value in the identified block 901 (1201).

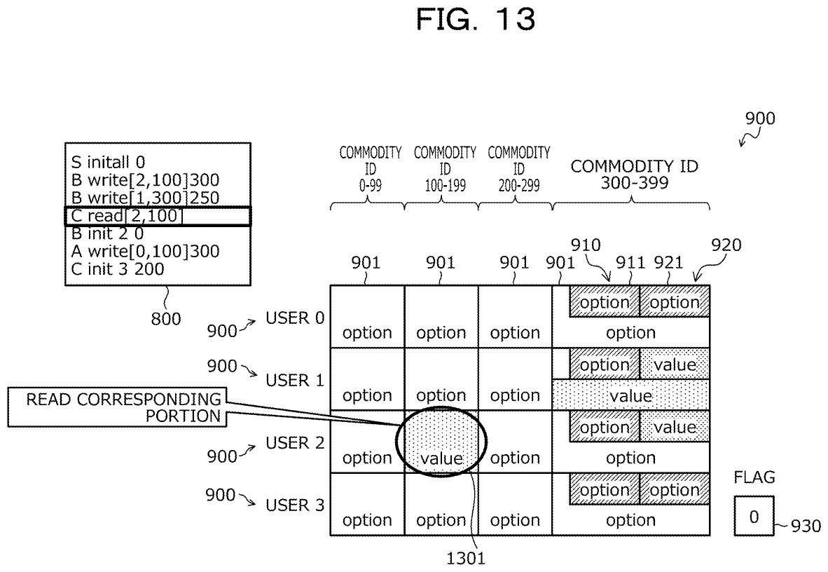

Accordingly, the information processing apparatus 100 may appropriately process the write request “B write[1,300]250”, and may store the value=250 of the component having the commodity id=300 in the block string 900 corresponding to user R₁. The information processing apparatus 100 may reduce the processing load and processing time taken when the write request is processed to O (1). Next, description will be given with reference to FIG. 13.

In FIG. 13, the information processing apparatus 100 extracts the read request “C read[2,100]” from the query queue 800 and processes the request. read[a,b] indicates that the value of the component having the commodity id=b is read from the block string 900 corresponding to user Rₐ. In this case, the information processing apparatus 100 identifies the block 901 (1301) associated with the component having the commodity id=100 in the block string 900 corresponding to user R₂.

The information processing apparatus 100 refers to the identified block 901 (1301) and reads the value of the component having the commodity id=100. When the identified block 901 (1301) is in the option state, the information processing apparatus 100 refers to the second area 921 of the block string 900 corresponding to user R₂ and reads the initial value as the value of the component having the commodity id=100.

When the identified block 901 (1301) is in the value state in the M area, the information processing apparatus 100 reads the value of the component having the commodity id=100 from the identified block 901 (1301). When the identified block 901 (1301) is in the value state in the W area, the information processing apparatus 100 reads the value of the component having the commodity id=100 from another block 901 indicated by the pointer in the head area of the identified block 901 (1301).

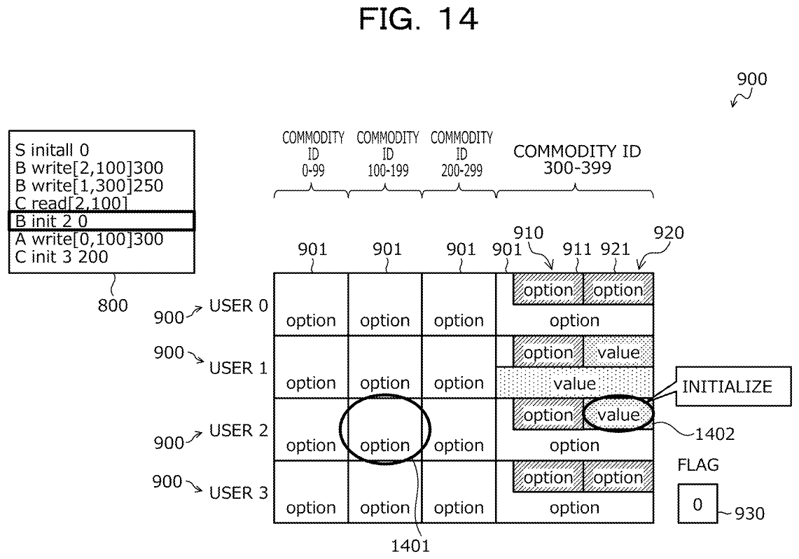

Accordingly, the information processing apparatus 100 may appropriately process the read request “C read[2,100]”, and may read the value of the component having the commodity id=100 from the block string 900 corresponding to the user R₂. The information processing apparatus 100 may reduce the processing load and processing time taken when the read request is processed to O (1). Next, description will be given with reference to FIG. 14.

In FIG. 14, the information processing apparatus 100 extracts the row initialization request “B init 2 0” from the query queue 800 and processes the request. init a b indicates that the entire block string 900 corresponding to user Rₐ is initialized with the value b.

In this case, the information processing apparatus 100 updates the second area string 920 such that the pair of the stack pointer for the block string 900 corresponding to user R₂ and an initial value is initialized. For example, the information processing apparatus 100 updates the second area string 920 such that the pair of the stack pointer=0 for the block string 900 corresponding to user R₂ and the initial value=0 is initialized.

For example, the information processing apparatus 100 stores the pair of the stack pointer=0 for the block string 900 corresponding to user R₂ and the initial value=0 in the second area 921. As a result, the information processing apparatus 100 returns the state of the block 901 (1401) of the block string 900 corresponding to user R₂ to the option state.

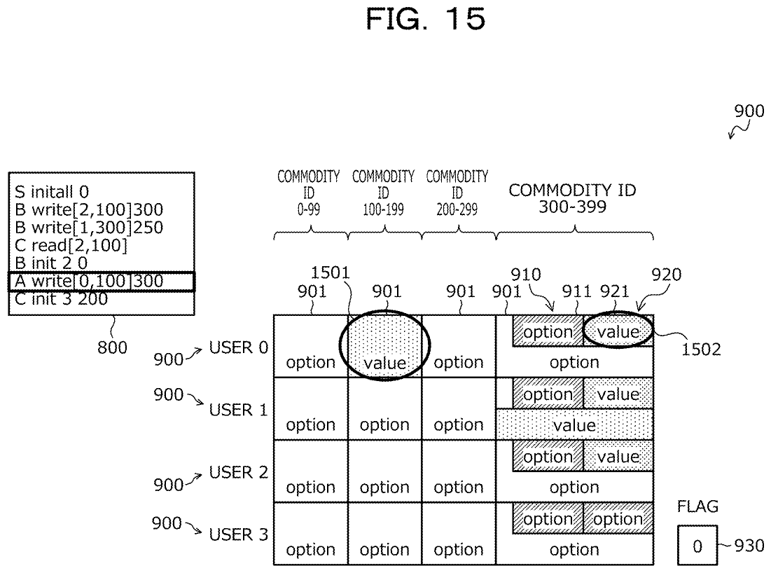

Accordingly, the information processing apparatus 100 may appropriately process the row initialization request “B init 2 0”, and may initialize the entire block string 900. The information processing apparatus 100 may reduce the processing load and processing time taken when the entire block string 900 is initialized to O (1). Next, description will be given with reference to FIG. 15.

In FIG. 15, the information processing apparatus 100 extracts the write request “A write[0,100]300” from the query queue 800 and processes the request. In this case, the information processing apparatus 100 identifies the block 901 (1501) associated with the component having the commodity id=100 in the block string 900 corresponding to user R₀. The information processing apparatus 100 updates the second area string 920 such that the second area 921 (1502) at the end of the block string 900 corresponding to user R₀ is a value area.

The information processing apparatus 100 stores a pair of the stack pointer for the block string 900 corresponding to user R₀ and an initial value in the second area string 920 such that the identified block 901 (1501) is in the value state. The information processing apparatus 100 stores the value=300 of the component having the commodity id=100 in the identified block 901 (1501). When the identified block 901 (1501) is the block 901 that has been in the option state up to this point, the information processing apparatus 100 may store (the value of another component other than the component having the commodity id=100)=initial value in the identified block 901 (1501).

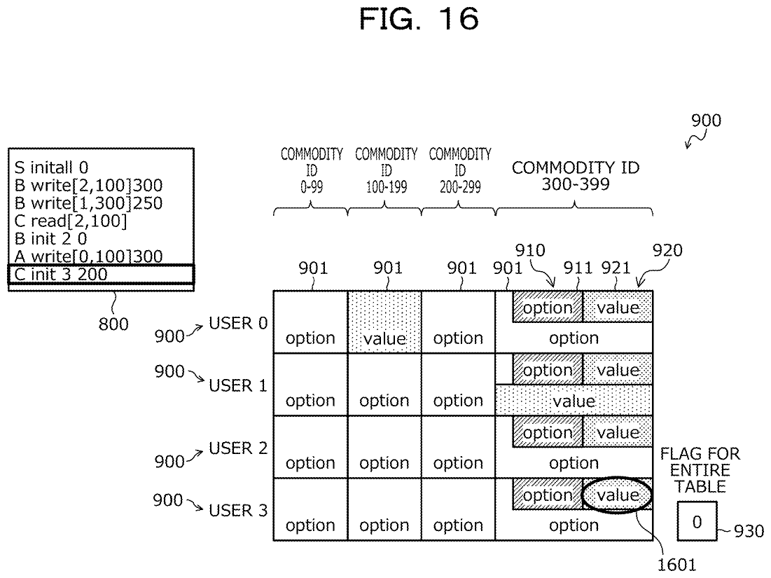

Accordingly, the information processing apparatus 100 may appropriately process the write request “A write[0,100]300”, and may store the value=300 of the component having the commodity id=100 in the block string 900 corresponding to user R₀. The information processing apparatus 100 may reduce the processing load and processing time taken when the write request is processed to O (1). Next, description will be given with reference to FIG. 16.

In FIG. 16, the information processing apparatus 100 extracts the row initialization request “C init 3 200” from the query queue 800 and processes the request. init a b indicates that the entire block string 900 corresponding to user Rₐ is initialized with the value b.

In this case, the information processing apparatus 100 updates the second area string 920 such that a pair of the stack pointer for the block string 900 corresponding to user R₃ and an initial value is initialized. For example, the information processing apparatus 100 updates the second area string 920 such that the pair of the stack pointer=0 for the block string 900 corresponding to user R₃ and the initial value=200 is initialized. For example, the information processing apparatus 100 stores the pair of the stack pointer=0 for the block string 900 corresponding to user R₃ and the initial value=200 in the second area 921 (1601).

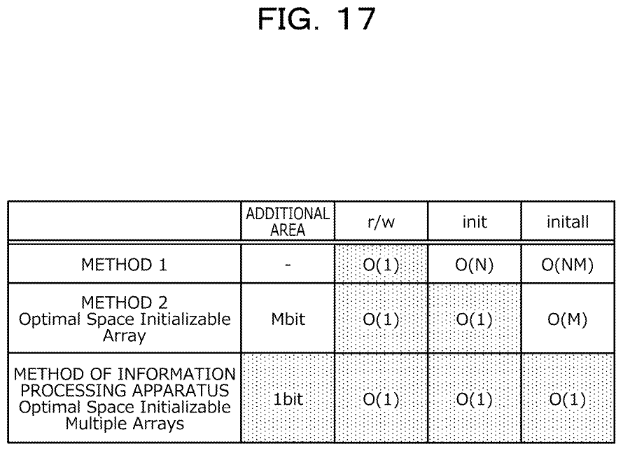

Accordingly, the information processing apparatus 100 may appropriately process the row initialization request “C init 3 200”, and may initialize the entire block string 900. The information processing apparatus 100 may reduce the processing load and processing time taken when the entire block string 900 is initialized to O (1). Next, description will be given with reference to FIG. 17, and an example of the effect produced by the information processing apparatus 100 will be described.

The table in FIG. 17 illustrates a result of comparison between the method of the information processing apparatus 100 illustrated in the second example and other methods. For example, the method of the information processing apparatus 100 may be referred to as optimal space initializable multiple arrays. For example, as another method, method 1 is conceivable in which a plurality of arrays itself is stored as data in an array format. For example, as another method, method 2 is conceivable in which, for each block string, flag information indicating whether the block string is in the full state is prepared in association with the block string.

For example, in method 1, the processing load and processing time taken when data in an array format corresponding to any array is initialized are O (N). For example, in method 1, the processing load and processing time taken when data in an array format corresponding to all arrays is initialized are O (NM). For example, in method 1, the processing load and processing time taken when a write request or a read request is processed are O (1).

For example, in method 2, the processing load and processing time taken when the block strings corresponding to all arrays are initialized are O (M). In method 2, since flag information is prepared for each array, the amount of data used when a plurality of block strings is stored is O (M). For example, in method 2, the processing load and processing time taken when a write request or a read request is processed are O (1).

By contrast, as described above, the method of the information processing apparatus 100 may reduce the processing load and processing time taken when a block string corresponding to any array is initialized to O (1). As described above, the method of the information processing apparatus 100 may reduce the processing load and processing time taken when the block strings corresponding to all arrays are initialized to O (1). As described above, the method of the information processing apparatus 100 may reduce the processing load and processing time taken when a write request or a read request is processed to O (1).

As described above, the method of the information processing apparatus 100 may reduce the amount of data used when a plurality of block strings is stored to O (1). As described above, the information processing apparatus 100 may enable initialization to be efficiently performed without increasing the processing load and processing time taken when a write request or a read request is processed, as compared with the other methods. At the same time, the information processing apparatus 100 may suppress an increase in the amount of data used when a plurality of block strings is stored.

### Procedure of Entire Initialization Processing

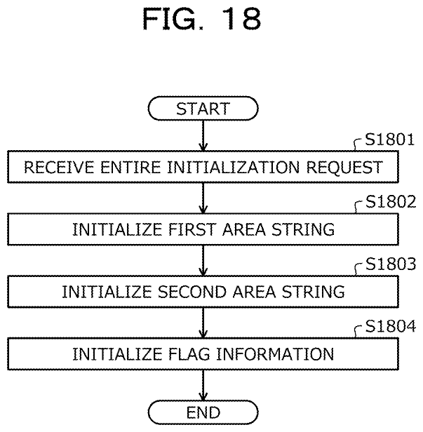

Next, an example of a procedure of entire initialization processing executed by the information processing apparatus 100 will be described with reference to FIG. 18. For example, the entire initialization processing is realized by the CPU 301, the storage area such as the memory 302 or the recording medium 305, and the network I/F 303 illustrated in FIG. 3.

FIG. 18 is a flowchart illustrating an example of the procedure of the entire initialization processing. In FIG. 18, the information processing apparatus 100 receives an entire initialization request (step S1801).

Next, in response to the entire initialization request, the information processing apparatus 100 initializes the first area string by initializing a pair of the stack pointer corresponding to the first area string and an initial value (step S1802). In response to the entire initialization request, the information processing apparatus 100 initializes the second area string by initializing a pair of the stack pointer corresponding to the second area string and an initial value (step S1803).

Next, the information processing apparatus 100 initializes flag information in response to the entire initialization request (step S1804). The information processing apparatus 100 ends the entire initialization processing.

### Procedure of Row Initialization Processing

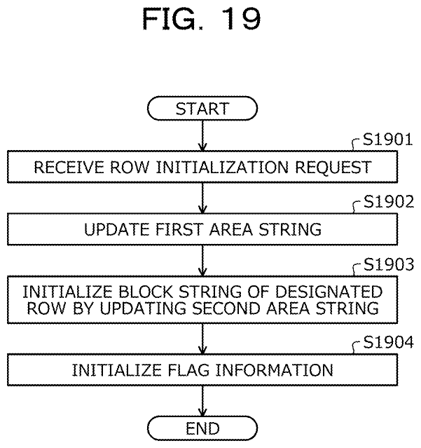

Next, an example of a procedure of row initialization processing executed by the information processing apparatus 100 will be described with reference to FIG. 19. For example, the row initialization processing is realized by the CPU 301, the storage area such as the memory 302 or the recording medium 305, and the network I/F 303 illustrated in FIG. 3.

FIG. 19 is a flowchart illustrating an example of the procedure of the row initialization processing. In FIG. 19, the information processing apparatus 100 receives a row initialization request including designation of any row (step S1901).

Next, in response to the row initialization request, the information processing apparatus 100 updates the first area string such that the first area included in the block string of the designated row is in the option state (step S1902). In response to the row initialization request, the information processing apparatus 100 initializes the block string of the designated row by updating the second area string such that a pair of the stack pointer corresponding to the block string of the designated row and an initial value is initialized (step S1903).

Next, the information processing apparatus 100 initializes flag information in response to the row initialization request (step S1904). The information processing apparatus 100 ends the row initialization processing.

### Procedure of Write Processing

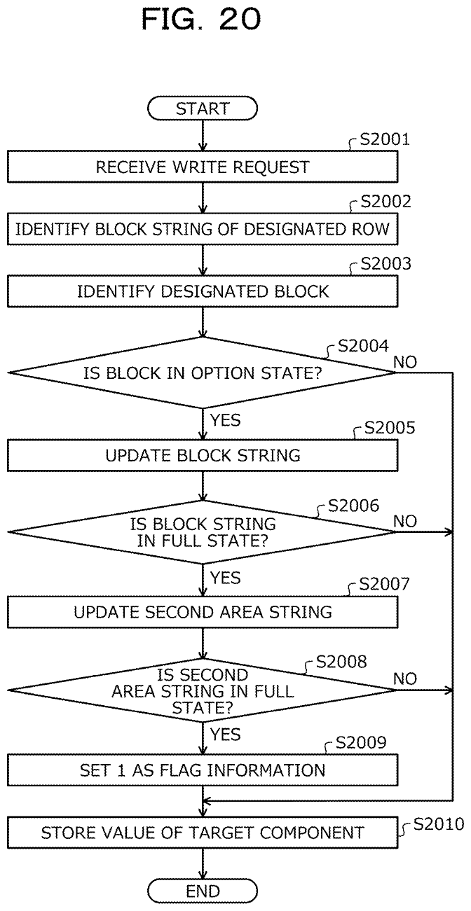

Next, an example of a procedure of write processing executed by the information processing apparatus 100 will be described with reference to FIG. 20. For example, the write processing is realized by the CPU 301, the storage area such as the memory 302 or the recording medium 305, and the network I/F 303 illustrated in FIG. 3.

FIG. 20 is a flowchart illustrating an example of the procedure of the write processing. In FIG. 20, the information processing apparatus 100 receives a write request including designation of a combination of any row and any block in the block string of the row, the combination being associated with a target component for which a value is to be written (step S2001).

Next, the information processing apparatus 100 identifies the block string of the designated row in response to the write request (step S2002). The information processing apparatus 100 identifies the designated block in the identified block string in response to the write request (step S2003).

Next, the information processing apparatus 100 determines whether the identified block is in the option state (step S2004). When the block is not in the option state (step S2004: No), the information processing apparatus 100 proceeds to the processing of step S2010. On the other hand, when the block is in the option state (step S2004: Yes), the information processing apparatus 100 proceeds to the processing of step S2005.

In step S2005, the information processing apparatus 100 updates the identified block string such that the identified block is entirely initialized and the state of the identified block is changed to the value state (step S2005).

Next, the information processing apparatus 100 determines whether the identified block string is in the full state (step S2006). When the block string is not in the full state (step S2006: No), the information processing apparatus 100 proceeds to the processing of step S2010. On the other hand, when the block string is in the full state (step S2006: Yes), the information processing apparatus 100 proceeds to the processing of step S2007.

In step S2007, the information processing apparatus 100 updates the second area string such that the second area included in the identified block string is in the value state (step S2007).

Next, the information processing apparatus 100 determines whether the second area string is in the full state (step S2008). When the second area string is not in the full state (step S2008: No), the information processing apparatus 100 proceeds to the processing of step S2010. On the other hand, when the second area string is in the full state (step S2008: Yes), the information processing apparatus 100 proceeds to the processing of step S2009.

In step S2009, the information processing apparatus 100 sets 1 as flag information (step S2009). The information processing apparatus 100 proceeds to the processing of step S2010.

In step S2010, the information processing apparatus 100 stores the value of the target component in the identified block (step S2010). The information processing apparatus 100 ends the write processing.

### Procedure of Read Processing

Next, an example of a procedure of read processing executed by

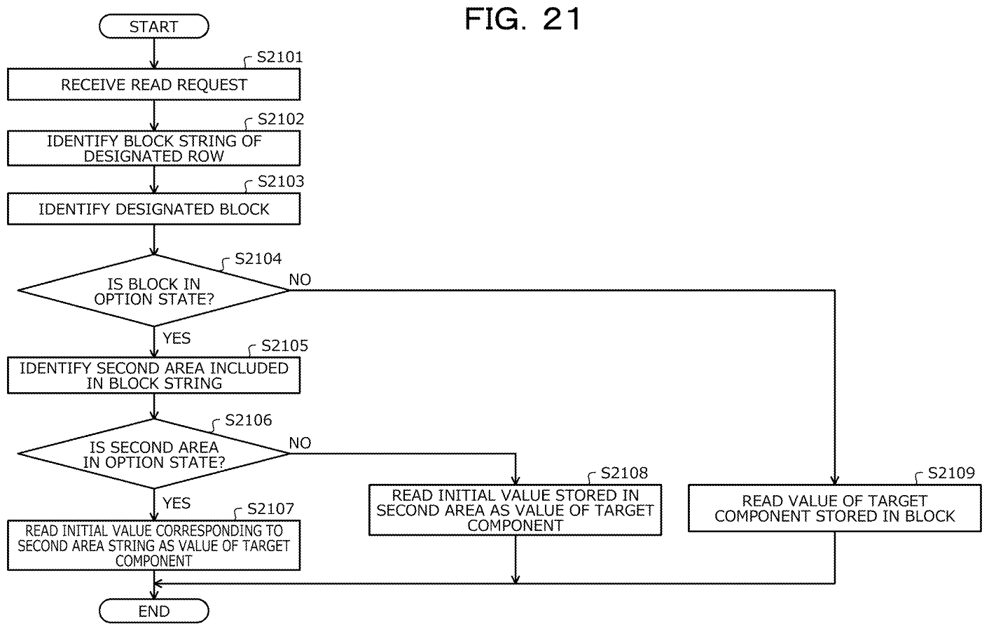

the information processing apparatus 100 will be described with reference to FIG. 21. For example, the read processing is realized by the CPU 301, the storage area such as the memory 302 or the recording medium 305, and the network I/F 303 illustrated in FIG. 3.

FIG. 21 is a flowchart illustrating an example of the procedure of the read processing. In FIG. 21, the information processing apparatus 100 receives a read request including designation of a combination of any row and any block in the block string of the row, the combination being associated with a target component for which a value is to be read (step S2101).

Next, the information processing apparatus 100 identifies the block string of the designated row in response to the read request (step S2102). The information processing apparatus 100 identifies the designated block in the identified block string in response to the read request (step S2103).

Next, the information processing apparatus 100 determines whether the identified block is in the option state (step S2104). When the block is not in the option state (step S2104: No), the information processing apparatus 100 proceeds to the processing of step S2109. On the other hand, when the block is in the option state (step S2104: Yes), the information processing apparatus 100 proceeds to the processing of step S2105.

In step S2105, the information processing apparatus 100 identifies the second area included in the identified block string (step S2105).

Next, the information processing apparatus 100 determines whether the identified second area is in the option state (step S2106). When the second area is not in the option state (step S2106: No), the information processing apparatus 100 proceeds to the processing of step S2108. On the other hand, when the second area is in the option state (step S2106: Yes), the information processing apparatus 100 proceeds to the processing of step S2107.

In step S2107, the information processing apparatus 100 reads the initial value corresponding to the second area string as the value of the target component (step S2107). The information processing apparatus 100 ends the read processing.

In step S2108, the information processing apparatus 100 reads the initial value stored in the identified second area as the value of the target component (step S2108). The information processing apparatus 100 ends the read processing.

In step S2109, the information processing apparatus 100 reads the value of the target component stored in the identified block (step S2109). The information processing apparatus 100 ends the read processing.

The information processing apparatus 100 may execute the processing of the flowcharts of FIGS. 18 to 21 by partly changing the order of the steps in each flowchart. The information processing apparatus 100 may partly omit the processing of the steps in each of the flowcharts of FIGS. 18 to 21.

As described above, according to the information processing apparatus 100, it is possible to store a plurality of block strings representing different arrays in which blocks associated with a predetermined number of components of an array are coupled. According to the information processing apparatus 100, for each block string of the plurality of block strings, it is possible to divide the block string into two portions. According to the information processing apparatus 100, when there is a front block corresponding only to components for which a value has not been set in the first half portion, it is possible to manage the block string such that the values of some components corresponding to a rear block in the latter half portion are distributed to the front block. According to the information processing apparatus 100, it is possible to divide into two portions a first area string in which the first areas in the last block of each block string are coupled. According to the information processing apparatus 100, when there is a front area corresponding only to components for which a value has not been set in the first half portion, it is possible to manage the first area string such that the values of some components corresponding to a rear area in the latter half portion are distributed to the front area. According to the information processing apparatus 100, it is possible to hold a pair of a pointer indicating the variable position at which each block string is divided and an initial value of components for which a value has not been set in the block string, by using the second area in the last block of each block string. According to the information processing apparatus 100, it is possible to store, in the first area string, flag information indicating whether there is an option area corresponding only to components for which a value has not been set. According to the information processing apparatus 100, when the first area that is a part of the last block is the option area according to the flag information, it is possible to treat each block string as a block string in which there is an option block corresponding only to components for which a value has not been set. According to the information processing apparatus 100, when the first area that is a part of the last block is not the option area according to the flag information, it is possible to treat each block string as a block string in which there is no option block. Accordingly, the information processing apparatus 100 may suppress an increase in the amount of data used when the plurality of block strings is stored.

According to the information processing apparatus 100, it is possible to divide into two portions a second area string in which the second areas in the last block of each block string are coupled. According to the information processing apparatus 100, when there is a front area corresponding to a pair for which a value has not been set in the first half portion, it is possible to manage the second area string such that a pair corresponding to a rear area in the latter half portion is distributed to the front area. According to the information processing apparatus 100, it is possible to hold, in some areas of the last area, a pointer indicating the variable position at which the second area string is divided and an initial value of a pair for which a value has not been set in the second area string. Accordingly, the information processing apparatus 100 may make it easier to initialize the second area string, and may make it easier to initialize the entire plurality of block strings by initializing the second area string.

According to the information processing apparatus 100, in the first area string, when there is a front area corresponding only to components for which a value has not been set in the first half portion of the two portions obtained by dividing the first area string, it is possible to distribute the values of some components corresponding to a rear area in the latter half portion to the front area. According to the information processing apparatus 100, it is possible to hold, in some areas of the last area, a pointer indicating the variable position at which the first area string is divided and an initial value of components for which a value has not been set in the first area string. Accordingly, the information processing apparatus 100 may achieve reduction of the amount of data used when the first area string is managed.

According to the information processing apparatus 100, it is possible to receive an initialization request for the entire plurality of block strings. According to the information processing apparatus 100, it is possible to store, in some areas of the last area of the second area string, a pointer indicating the head of the second area string as the position at which the second area string is divided and the initial value of a pair for which a value has not been set in the second area string. According to the information processing apparatus 100, it is possible to store, in some areas of the last area of the first area string, a pointer indicating the head of the first area string as the position at which the first area string is divided and the initial value of components for which a value has not been set in the first area string. According to the information processing apparatus 100, when the flag information is a value indicating that there is no option area in the first area string, the flag information may be updated to a value indicating that there is an option area. Accordingly, the information processing apparatus 100 may initialize the entire plurality of block strings. The information processing apparatus 100 may reduce the processing load and processing time taken when the entire plurality of block strings is initialized to O (1).

According to the information processing apparatus 100, it is possible to receive an initialization request for any entire block string of the plurality of block strings. According to the information processing apparatus 100, it is possible to set, as the pair corresponding to the second area in any block string, a pair of a pointer indicating the head of any block string and an initial value of components for which a value has not been set in any block string. According to the information processing apparatus 100, it is possible to update the first area string such that the first area of the first area string corresponding to any block string is the option area. According to the information processing apparatus 100, when the flag information is a value indicating that there is no option area in the first area string, the flag information may be updated to a value indicating that there is an option area. Accordingly, the information processing apparatus 100 may initialize the entire block string. The information processing apparatus 100 may reduce the processing load and processing time taken when the entire block string is initialized to O (1).

According to the information processing apparatus 100, it is possible to receive a write request of the value of any component of an array. According to the information processing apparatus 100, it is possible to identify a write destination block corresponding to any component in the plurality of block strings. According to the information processing apparatus 100, it is possible to determine whether the identified write destination block is an option block. According to the information processing apparatus 100, when the block is an option block, it is possible to write, to the identified write destination block, the value of any component of a predetermined number of components corresponding to the identified write destination block and an initial value of the remaining components different from any component. According to the information processing apparatus 100, when the block is not an option block, it is possible to write the value of any component to the identified write destination block. Accordingly, the information processing apparatus 100 may write the value of any component of an array.

According to the information processing apparatus 100, it is possible to receive a read request of the value of any component of an array. According to the information processing apparatus 100, it is possible to identify a read source block corresponding to any component in the plurality of block strings. According to the information processing apparatus 100, it is possible to determine whether the identified read source block is an option block. According to the information processing apparatus 100, when the block is an option block, it is possible to determine whether the second area corresponding to the identified read source block is an option area corresponding to a pair for which a value has not been set. According to the information processing apparatus 100, when the second area is an option area, it is possible to read the initial value of any component from some areas of the last area of the second area string. According to the information processing apparatus 100, when the second area is not an option area, it is possible to read the initial value of any component from the second area corresponding to the identified read source block. According to the information processing apparatus 100, when the identified read source block is not an option block, it is possible to read the value of any component from the identified read source block. Accordingly, the information processing apparatus 100 may read the value of any component of an array.

According to the information processing apparatus 100, it is possible to represent a block string by the data structure called block-wise optional array. According to the information processing apparatus 100, it is possible to represent the first area string by the data structure called block-wise optional array. According to the information processing apparatus 100, it is possible to represent the second area string by the data structure called block-wise optional array. Accordingly, the information processing apparatus 100 may efficiently manage a block string, the first area string, and the second area string.

The information processing method described in the present embodiment may be implemented by causing a computer, such as a PC or a workstation, to execute a program prepared in advance. The information processing program described in the present embodiment is executed by being recorded on a computer-readable recording medium and read from the recording medium by the computer. The recording medium is a hard disk, a flexible disk, a compact disc (CD)-ROM, a magneto optical (MO) disc, a Digital Versatile Disc (DVD), or the like. The information processing program described in the present embodiment may be distributed via a network, such as the Internet.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing an information processing program for causing a computer to execute a process comprising:
storing a plurality of block strings that represents different arrays in which blocks associated with a predetermined number of components of an array are coupled;
in each block string of the plurality of block strings, managing the block string such that, when there is a front block corresponding only to components for which a value has not been set in a first half portion of two portions obtained by dividing the block string, at least a plurality of areas that is a part of a last block is unused areas where values of components are not stored, by distributing values of some components corresponding to a rear block in a latter half portion to the front block;
in a first area string in which first areas of the plurality of areas in a last block of the each block string are coupled, when there is a front area corresponding only to components for which a value has not been set in a first half portion of two portions obtained by dividing the first area string, managing the first area string such that values of some components corresponding to a rear area in a latter half portion are distributed to the front area;
for the each block string, holding a pair of a pointer that indicates a variable position at which the block string is divided and an initial value of components for which a value has not been set in the block string, by using a second area of the plurality of areas in the last block of the each block string; and
storing flag information that indicates whether there is an option area corresponding only to components for which a value has not been set in the first area string,
wherein
according to the flag information, the each block string is treated as a block string in which there is an option block corresponding only to components for which a value has not been set when the first area that is a part of a last block is the option area, and is treated as a block string in which there is no option block when the first area that is a part of a last block is not the option area.

2. The non-transitory computer-readable recording medium according to claim 1, wherein
the second area is associated with a pair of a pointer that indicates a variable position at which a block string including the second area is divided and an initial value of components for which a value has not been set in the block string, and
the computer is caused to execute a process of, in a second area string in which the second area of a last block of the each block string is coupled, when there is a front area corresponding to the pair for which a value has not been set in a first half portion of two portions obtained by dividing the second area string, managing the second area string such that at least some areas of a last area are unused areas where the pair is not stored by managing the second area string such that the pair corresponding to a rear area in a latter half portion is distributed to the front area, and holding, in the some areas, a pointer that indicates a variable position at which the second area string is divided and an initial value of the pair for which a value has not been set in the second area string.

3. The non-transitory computer-readable recording medium according to claim 2, wherein
the managing of the first area string includes
managing the first area string such that, in the first area string, when there is a front area corresponding only to components for which a value has not been set in a first half portion of two portions obtained by dividing the first area string, at least some areas of a last area are unused areas where values of components are not stored, by distributing values of some components corresponding to a rear area in a latter half portion to the front area, and holding, in the some areas, a pointer that indicates a variable position at which the first area string is divided and an initial value of components for which a value has not been set in the first area string.

4. The non-transitory computer-readable recording medium according to claim 3, wherein
the computer is caused to execute a process including
in response to reception of an initialization request for the plurality of block strings, storing, in some areas of a last area of the second area string, a pointer that indicates a head of the second area string as a position at which the second area string is divided and an initial value of the pair for which a value has not been set in the second area string,
in response to reception of an initialization request for the plurality of block strings, storing, in some areas of a last area of the first area string, a pointer that indicates a head of the first area string as a position at which the first area string is divided and an initial value of components for which a value has not been set in the first area string, and
in response to reception of an initialization request for the plurality of block strings, when the flag information is a value that indicates that there is no option area in the first area string, updating the flag information to a value that indicates that there is the option area.

5. The non-transitory computer-readable recording medium according to claim 4, wherein
the computer is caused to execute a process including
in response to reception of an initialization request for an entirety of any block string of the plurality of block strings, updating the second area corresponding to the any block string such that, as a pair corresponding to the second area in the any block string, a pair of a pointer that indicates a head of the any block string as a position at which the any block string is divided and an initial value of components for which a value has not been set in the any block string is set,
in response to reception of an initialization request for the entirety of any block string, updating the first area string such that the first area of the first area string corresponding to the any block string is the option area, and
in response to reception of an initialization request for the entirety of any block string, when the flag information is a value that indicates that there is no option area in the first area string, updating the flag information to a value that indicates that there is the option area.

6. The non-transitory computer-readable recording medium according to claim 4, wherein
the computer is caused to execute a process including
in response to reception of a write request of a value of any component of the array, identifying a write destination block corresponding to the any component in the plurality of block strings,
when the write destination block that has been identified is the option block, writing, to the write destination block that has been identified, a value of the any component of a predetermined number of components corresponding to the write destination block that has been identified and an initial value of remaining components different from the any component, and
when the write destination block that has been identified is not the option block, writing a value of the any component to the write destination block that has been identified.

7. The non-transitory computer-readable recording medium according to claim 4, wherein
the computer is caused to execute a process including
in response to reception of a read request of a value of any component of the array, identifying a read source block corresponding to the any component in the plurality of block strings,
when the read source block that has been identified is the option block and the second area corresponding to the read source block that has been identified is an option area corresponding to the pair for which a value has not been set, reading an initial value of the any component from some areas of a last area of the second area string,
when the read source block that has been identified is the option block and the second area corresponding to the read source block that has been identified is not an option area corresponding to the pair for which a value has not been set, reading an initial value of the any component from the second area corresponding to the read source block that has been identified, and
when the read source block that has been identified is not the option block, reading a value of the any component from the read source block that has been identified.

8. The non-transitory computer-readable recording medium according to claim 4, wherein
the block string is block-wise optional array,
the first area string is block-wise optional array, and
the second area string is block-wise optional array.

9. An information processing method performed by a computer, the method comprising:
storing a plurality of block strings that represents different arrays in which blocks associated with a predetermined number of components of an array are coupled;
in each block string of the plurality of block strings, managing the block string such that, when there is a front block corresponding only to components for which a value has not been set in a first half portion of two portions obtained by dividing the block string, at least a plurality of areas that is a part of a last block is unused areas where values of components are not stored, by distributing values of some components corresponding to a rear block in a latter half portion to the front block;
in a first area string in which first areas of the plurality of areas in a last block of the each block string are coupled, when there is a front area corresponding only to components for which a value has not been set in a first half portion of two portions obtained by dividing the first area string, managing the first area string such that values of some components corresponding to a rear area in a latter half portion are distributed to the front area;
for the each block string, holding a pair of a pointer that indicates a variable position at which the block string is divided and an initial value of components for which a value has not been set in the block string, by using a second area of the plurality of areas in the last block of the each block string; and
storing flag information that indicates whether there is an option area corresponding only to components for which a value has not been set in the first area string,
wherein
according to the flag information, the each block string is treated as a block string in which there is an option block corresponding only to components for which a value has not been set when the first area that is a part of a last block is the option area, and is treated as a block string in which there is no option block when the first area that is a part of a last block is not the option area.

10. An information processing apparatus comprising:
a memory, and
a processor coupled to the memory and configured to:
store a plurality of block strings that represents different arrays in which blocks associated with a predetermined number of components of an array are coupled;
in each block string of the plurality of block strings, manage the block string such that, when there is a front block corresponding only to components for which a value has not been set in a first half portion of two portions obtained by dividing the block string, at least a plurality of areas that is a part of a last block is unused areas where values of components are not stored, by distributing values of some components corresponding to a rear block in a latter half portion to the front block;
in a first area string in which first areas of the plurality of areas in a last block of the each block string are coupled, when there is a front area corresponding only to components for which a value has not been set in a first half portion of two portions obtained by dividing the first area string, manage the first area string such that values of some components corresponding to a rear area in a latter half portion are distributed to the front area;
for the each block string, hold a pair of a pointer that indicates a variable position at which the block string is divided and an initial value of components for which a value has not been set in the block string, by using a second area of the plurality of areas in the last block of the each block string; and
store flag information that indicates whether there is an option area corresponding only to components for which a value has not been set in the first area string,
wherein
according to the flag information, the each block string is treated as a block string in which there is an option block corresponding only to components for which a value has not been set when the first area that is a part of a last block is the option area, and is treated as a block string in which there is no option block when the first area that is a part of a last block is not the option area.
